(19) United States
(12) Patent Application Publication
(10) Pub. No.: US 2015/0309321 A1
(43) Pub. Date: Oct. 29, 2015

(54) DEVICES FOR INTEGRAL IMAGES AND MANUFACTURING METHOD THEREFORE

(71) Applicants: Axel LUNDVALL, Bjursas (SE); Karolina LUNA, Drammen (NO); Lukas AHRENBERG, Dals Langed (SE)

(72) Inventors: Axel LUNDVALL, Bjursas (SE); Karolina LUNA, Drammen (NO); Lukas AHRENBERG, Dals Langed (SE)

(73) Assignee: ROLLING OPTICS AB, Stockholm (SE)

(21) Appl. No.: 14/792,223

(22) Filed: Jul. 6, 2015

Related U.S. Application Data
(62) Division of application No. 13/202,545, filed on Aug. 19, 2011.

(30) Foreign Application Priority Data
Feb. 20, 2009 (SE) 0950095-0
Apr. 23, 2009 (SE) 0950269-1

(51) Int. Cl. G02B 27/22; G02B 3/00

(52) U.S. Cl. CPC G02B 27/2214; G02B 3/0056

(57) ABSTRACT

An integral image device, comprises a focusing element array of focusing elements in a focusing element plane and an image array of cells in an image plane. The cells comprise structures that are optically distinguishable. The image plane is situated at a distance from the focusing element plane being in a vicinity of a focal length of the focusing elements. The structures together provide an integral image when being viewed through the focusing elements. The structures of each individual cell are individually adapted to provide different scenes of the integral image for different angles in which the integral image is viewed. The dimensional models comprises at least one three-dimensional model.

This application is a Divisional of copending application Ser. No. 13/202,545, filed on Aug. 19, 2011, which was filed as PCT International Application No. PCT/EP2010/051956 on Feb. 17, 2010, which claims the benefit under 35 U.S.C. §119(a) to Patent Application No. 0950095-0, tiled in Sweden on Feb. 20, 2009 and Patent Application No. 0950269-1, filed in Sweden on Apr. 23, 2009, all of which are hereby expressly incorporated by reference into die present application.

### TECHNICAL FIELD

The present invention relates in general to optical devices and manufacturing thereof, and in particular to devices for synthetic integral images and computer-assisted manufacturing thereof.

### BACKGROUND

Planar optical arrangements giving rise to a synthetic, more or less three-dimensional, integral image or an image that changes its appearance at different angles have been used in many applications. Besides purely esthetical uses, such arrangements have been used e.g. as security labels on bank-notes or other valuable documents, identification documents etc. The synthetic three-dimensional images have also been used for providing better geometrical understanding of complex shapes in e.g. two-dimensional information documents.

One type of integral image devices comprises an array of microimages which, when viewed through a corresponding array of focusing elements generates a magnified image. The distance between the microimages and the focusing elements is close to the focal length of the focusing elements. This result is achieved according to the long known Moiré effect. Examples of such arrangements can be found in e.g. the published international patent application WO 94/27254 and in the published US patent application US 2005/0180020.

In a typical Moiré type of integral image device, the array of microimages is a periodic array in two dimensions. In order to achieve a Moiré effect, the distance between two adjacent microimages is different from, but close to, the distance between two adjacent focusing elements. An integral image composed by the images shown by each of the focusing elements will resemble a magnified version of the structures of the microimage. The magnification is determined by the relation between the distance Pₒ between two adjacent microimages and the distance P₁ between two adjacent focusing elements, i.e. the relation between the array pitches. The magnification M is typically given as M=1/(F−F²), where F=P₀/P₁. By having a very small pitch difference, a large magnification can thus be achieved. The integral image will appear as a two-dimensional image at a certain depth below (or height above) the surface of the optical device, a so-called 2D/3D image. The apparent image depth dᵢ can in the case of using spherical microlenses as focusing elements be expressed as dᵢ=(f−Rₗ)/(1−F)+Rₗ, where f is a focal length of the spherical microlenses and Rₗ is the radius of the curvature of the spherical microlenses. These conditions are operating well for relatively small repeated objects in one (or several distinct) apparent image planes. However, if a large integral image is required, extremely high magnifications have to be used, which in turn defines the image to appear on a certain depth and puts extreme demands on the resolution of the microimages. Furthermore, the integral images are basically two-dimensional in that sense that the integral image appears at a certain plane, even if this plane may be situated at an apparent image depth (2D/3D image). There are some limited possibilities to achieve three-dimensional integral images by varying design parameters of the optical device over its surface, e.g. microlens radius, focal length or pitch relation. However, it is almost impossible to construct a true three-dimensional perception in this way.

In the published international patent application WO 2007/115244 a sheeting presenting a composite floating image is disclosed. A layer of microlenses covers a surface with radiation sensitive material. By exposing the arrangement for high-energy radiation, the radiation sensitive material records the distribution of radiation that has passed through the lens array. The radiation distribution carries information about the three-dimensional properties of the radiation. When the arrangement later is exposed for light, a floating image resembling the high-energy radiation can be viewed. This arrangement is thus a variation of integral photography. However, the use of photographic recording without developing processes gives images of low quality and the need of radiation exposure of the assembled arrangement is unsuitable for low-cost industrial production of various motives.

### SUMMARY

An object of the present invention is to provide integral image devices, which provides for integral images of any size and without requirement of being repeated. A further object of the present invention is to provide integral image devices, which provides for three-dimensional integral images.

The above objects are achieved by methods and devices according to the enclosed patent claims. In general words, in a first aspect, an integral image device, comprises a focusing element array of focusing elements in a focusing element plane and an image array of cells in an image plane. The cells comprises structures that are optically distinguishable. The image plane is situated at a distance from the focusing element plane being in a vicinity of a focal length of the focusing elements. The structures together provide an integral image when being viewed through the focusing elements. The structures of each individual angles in which the integral image is viewed. The scenes present different viewing angles of a set of three-dimensional models. The set of three-dimensional models comprises at least one three-dimensional model.

One advantage with the present invention is that an integral image of any three-dimensional object can be produced, even need for the object to have existed in reality.

### BRIEF DESCRIPTION OF THE DRAWINGS

The invention, together with further objects and advantages thereof, may best be understood by making reference to the following description taken together with the accompanying drawings, in which:

FIG. 1A is a schematic enlarged cross-sectional view of an embodiment of an integral image device according to the present invention;

FIGS. 1B-E are views from above of an enlarged part of different embodiments of an integral image device according to the present invention;

FIGS. 2A-D illustrate the division of virtual cells into pixels;

FIGS. 3A-B are schematic illustrations of models of an object to be imaged;

FIGS. 4A-B are illustrations of creation of projections of a model of an object to be imaged in virtual cells;

FIG. 5A is a schematic illustration of an embodiment of a three-dimensional object to be imaged;

FIGS. 5B-E are projections of the embodiment of the three-dimensional object to be imaged of FIG. 5A in different direction;

FIGS. 6A-B are illustrations of depth enhancing modifications of projections;

FIGS. 7A-C are schematic illustrations of processes for creating tools useful in an embodiment of a method according to the present invention;

FIG. 7D-F are schematic illustrations of processes for using tools in an embodiment of a method according to the present invention;

FIG. 8A-C are illustrations of different focusing elements;

FIG. 9 is a flow diagram of steps according to an embodiment of a manufacturing method according to the present invention;

FIGS. 10A-B illustrate the conditions for allocating associated models to a pixel;

FIGS. 11A-D illustrate portions of embodiments of an integral image device according to the present invention;

FIGS. 12A-D illustrate an embodiment of an integral image device according to the present invention when viewed in different direction;

FIG. 12E illustrate a single microlens in the embodiment of FIGS. 12A-D and structures at an image plane below the microlens;

FIG. 13 illustrates an embodiment of an integral image device presenting letters appearing at well determined viewing angles relative to each other; and

FIG. 14 illustrates a portion of an embodiment of an integral image device according to the present invention providing fading integral images.

### DETAILED DESCRIPTION

In the drawings, corresponding reference numbers are used for similar or corresponding parts.

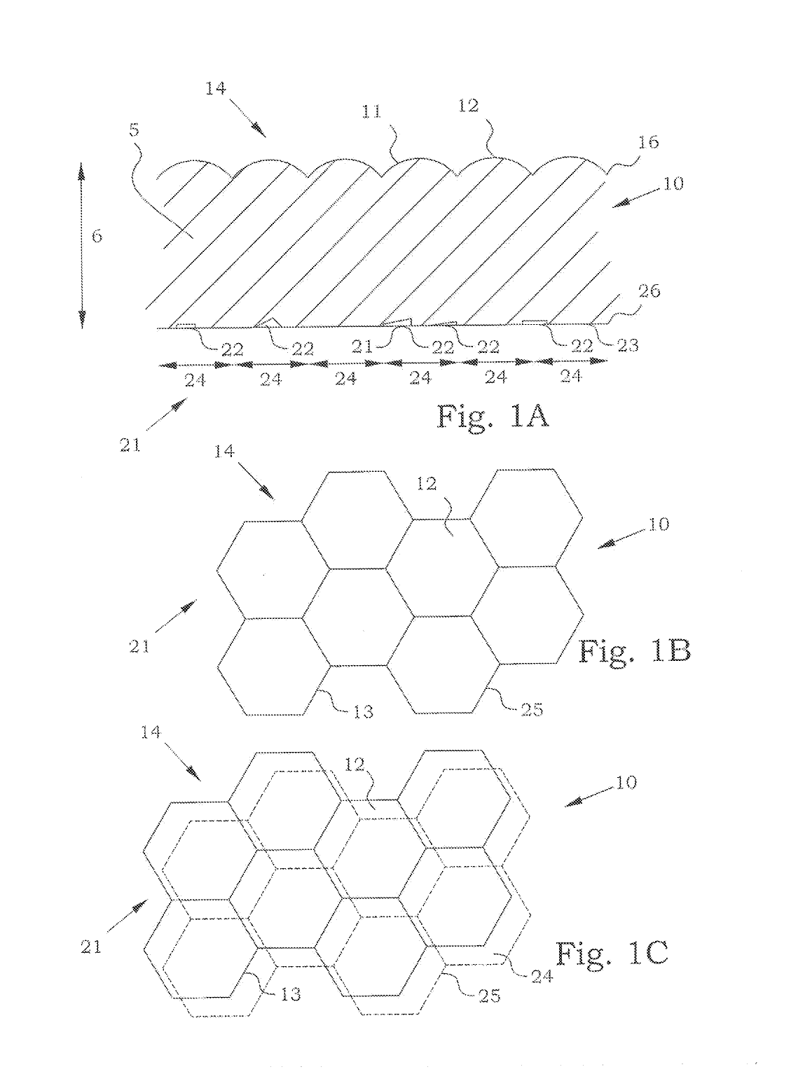

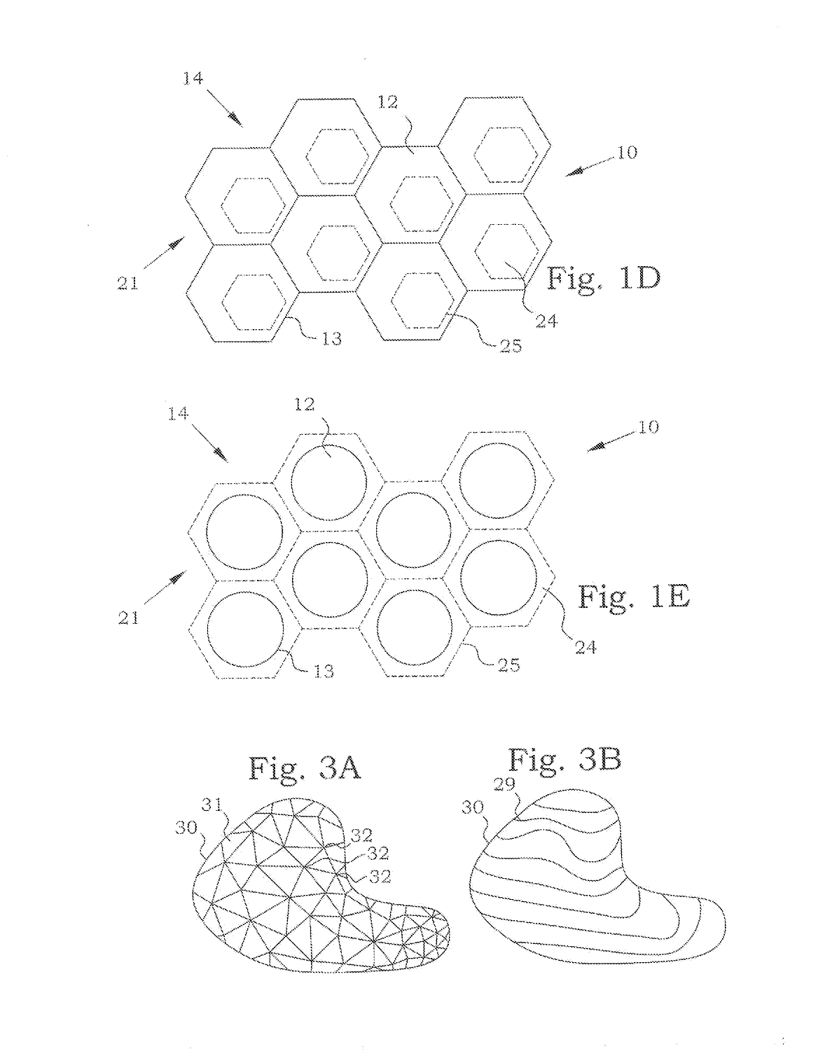

FIG. 1A illustrates a partial cross section view of an integral image device 10, comprising a polymer foil 5 and giving scenes of an integral image when viewed from one side in different directions. The thickness direction of the polymer foil is denoted by 6. The integral image device comprises a focusing element array 14 of microlenses 12 in a focusing element plane 16. A microlens 12 is an example of a focusing element 11. Other types of focusing elements 11, such as e.g. curved mirrors are also possible to use, as described further below. Below (as defined in the figure) the focusing element plane 16, the integral image device 10 comprises an image plane 26, at which structures 22 that are optically distinguishable are provided. The structures 22 are in the present embodiment embossed structures 21 in an interface 23. However, the structures 22 can in alternative embodiments e.g. comprise printed structures.

In alternative embodiments, the integral image device 10 could comprise a stack of polymer foils, together forming at least the main part of the integral image device.

The focusing element plane 16 is provided by an interface of the polymer foil 5 or stack of foils. This interface is typically a surface of the polymer foil 5. However, the interface could also be any interface to another material exhibiting different optical properties. The image plane 26 is provided by an interface of the polymer foil 5 or stack of foils. This interface is typically another surface of the polymer foil 5. However, the interface could also be any interface to another material exhibiting different optical properties.

Each microlens 12 has a respective cell 24 at the image plane 26. The cells 24 are distributed according an image array 21. In the present embodiment, the respective cell 24 is situated straight below the corresponding microlens 12, along the thickness direction 6. Such a configuration is illustrated by FIG. 1B, where a portion of an integral image device 10 is shown from above. In this embodiment, the microlenses 12 are provided in a closed-packed array, forming hexagonal borders 13. In the present embodiment, the cells are of the same size as the microlenses 12 and furthermore aligned therewith in the lateral direction. Borders 25 between the adjacent cells 24 are therefore situated exactly below the borders 13 between the microlenses 12.

This is a typical case, but other arrangements are also possible. The respective cell 24 can for instance be situated with a lateral offset with respect to the corresponding microlens 12. This is illustrated in FIG. 1C. In such an arrangement, a lateral offset of the integral image will be introduced. Furthermore, the centre angle in the field of view for viewing the final integral image is offset from the normal to the focusing element plane. Usually, this is a situation that should be avoided, but in certain special applications, this may be useful as well.

In the embodiment of FIG. 1A, the cell 24 is equal to the area of the corresponding microlens 12. Thus, the cells 24 together cover the entire image plane 26, i.e. they together form a continuous image area. In other words, the cells are provided edge to edge. However, in other embodiments, the cell 24 can be smaller than the area of the corresponding microlens 12. This is illustrated by FIG. 1D. There, the cells 24 together cover less than the entire image plane. In other words, at least one cell of the plurality of cells 24 is separated with a distance from the other cells 24.

Also, in particular in cases where the microlenses 12 do not cover the entire surface, the cell 24 can be larger than the area of the corresponding microlens 12. This is illustrated in FIG. 1E. The microlenses 12 are here separated by a distance, while the cells 24 are close-packed. Of course, the cells 24 could in an alternative embodiment also be arranged in any other configuration.

In the embodiments of FIGS. 1B-E, the focusing element array 14 and the image array 21 are conform to each other. This means that the distance and lateral direction between the centre points of two focusing elements is the same as the distance and lateral direction between centre points of cells corresponding to these two focusing elements. The focusing element array 14 as such and the image array 21 as such have the same shape and size, even if the focusing elements and cells positioned at the different mode points of the array are differing. However, as mentioned above, it is not an absolute necessity that the focusing element array 14 and the image array 21 are laterally aligned with each other, even if that is the typical and preferred situation in most cases.

The cell 24 comprises those optically distinguishable structures 22 that are intended to be imaged by the corresponding microlens 12 within a certain two-dimensional angle interval. The integral image that can be viewed in a certain direction is referred to as a scene. The integral image typically changes its appearance when changing the viewing angle and in some cases also when changing the viewing position relative the integral image device. The viewing angle refers to the angle relative the normal of the device surface for a reference point at the device. In most cases, where an infinite viewing distance can be used as an approximation, the reference point becomes arbitrary. The viewing position is similarly referring to the assumed viewing position with reference to the reference point. Each such perceived image is a scene. If one single three-dimensional object is imaged, the different scenes are constituted by different viewing angles of this three-dimensional object.

The image plane 26 is situated at a distance from the lens plane 16 that is in the vicinity of a focal length of the microlenses 12.

The integral image device 1 according to the embodiment of FIG. 1A has many common features with prior art Moiré image devices. However, an important difference is that the structures 22 of the cells 24 not necessarily have to be repeated periodically. Instead, the structures 22 of each individual cell 24 are individually adapted to provide the structures necessary for creating an integral image, and more particularly for creating a specific scene of an integral image in each viewing direction.

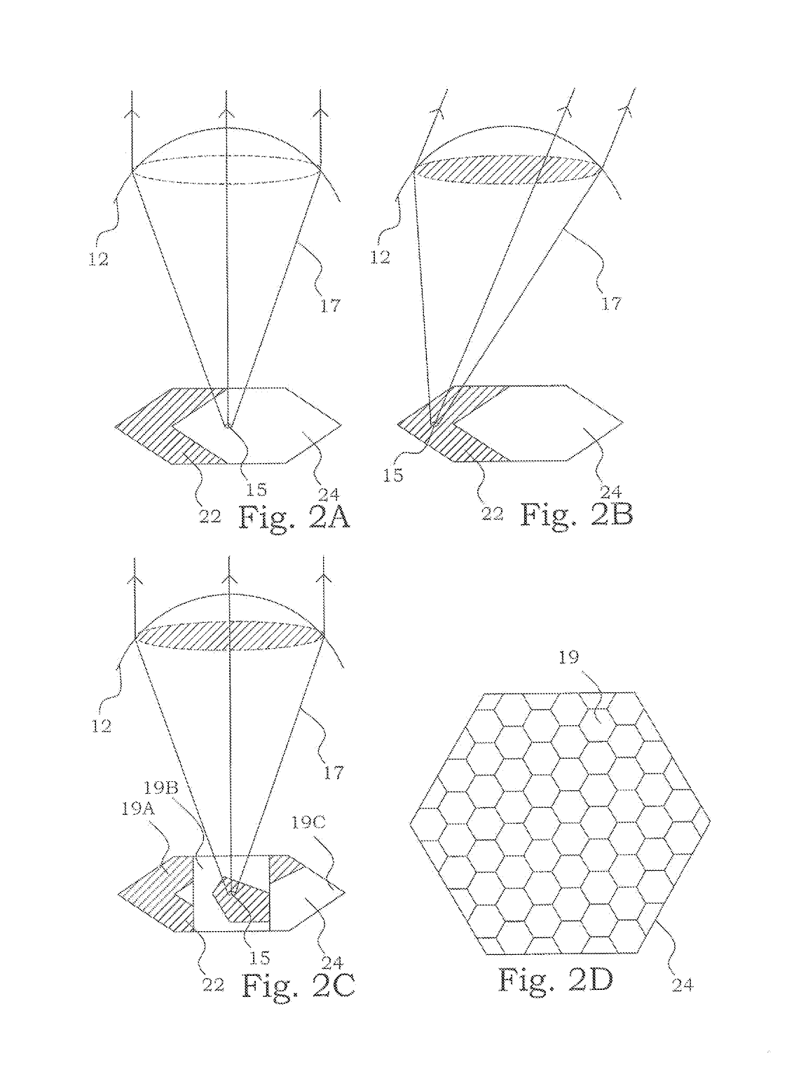

In FIG. 2A, a pair of a microlens 12 and a corresponding cell 24 is schematically illustrated. In this explanatory example, the cell 24 comprises optically distinguishable structures 22 at the left side, illustrated with a hatching, while the right side is “empty”. When viewing the microlens 12 from a position straight above the microlens 12, light rays 17 emanating from a small area 15 in the middle of the cell 24 will be refracted and leave the microlens 12 as parallel rays in a perpendicular direction. A viewer positioned straight in front of the microlens 12 will thereby perceive an enlarged image of structures in the area 15 spread over the area of the microlens 12. In reality, the perceived image is typically distorted by the actual optical properties of the microlens, such as aberrations, the focal length vs. film thickness etc., however, the information in the area 15 is in some manner displayed spread over the entire area of the microlens 12. However, in this case, the area 15 is free from structures 22 and the image shown over the microlens 12 will also be structureless.

In FIG. 2B, the same pair of a microlens 12 and a corresponding cell 24 is schematically illustrated. However, here another assumed viewing angle is illustrated. The viewer is now assumed to watch the microlens 12 in an angle to the right in the figure. The light rays 17 that now reaches the viewer emanates from another small area 15 in the cell 24. In this particular explanatory example, the area 15 includes a part of the optically distinguishable structures 22. The viewer will thus in this angle perceive an enlarged (and perhaps distorted) version of the structures 22. When the viewer changes the viewing direction from the one illustrated in FIG. 2A to the one of FIG. 2B, he will therefore perceive that the object being the origin for the structures 22 moves in under the microlens 12 area. This gives an impression of a depth in the image and gives rise to a three-dimensional perception.

In other words, every small area within the cell 24 comprises the information that is thought to be presented when the optical device is viewed in a specific direction, i.e. information necessary to create a specific scene. In a typical case, where a stationary three-dimensional object is to be presented, the information in the different parts of the cell 24 comprises information of the same object only viewed from another angle. However, having the insight that every part of the cell contains specific imaging information for a specific direction of view, this feature opens up for further generalizations. By providing for a plurality of pixels in each cell, a composite integral image can be achieved.

In FIG. 2C, the cell 24 is divided into three pixels 19A-C. A first pixel 19A is situated at the left side and comprises the same structures 22 as in FIGS. 2A and 2B. However, the middle pixel 19B comprises other optically distinguishable structures 22, being created based on another model or object. Finally, the third pixel 19C comprises further other optically distinguishable structures 22, being created based on yet another model. Each pixel is thus associated with a separate model. Since the “models” of the different pixels can be of any kind, it can also be e.g. the same object but viewed from another direction or under other conditions. A more general concept would therefore be to associate a “model” to every pixel, where the “model” could be an object or other visual perception viewed from a specific direction or under specific conditions. A set of “models” is thereby created, from which a “model” is selected to be associated with each pixel.

When viewing the optical device of FIG. 2C from the right side, the information shown at the microlens will be the same as in FIG. 2B. However, when viewing the optical device from a position straight above the microlens, the imaged small area of the cell appears within the middle pixel 19B, and gives rise to an image at the microlens that is associated with another “model”. Finally, when viewing the microlens from the left side, the third “model” will be presented over the microlens area in that scene. The scene in this direction thus differs from the scene seen from the right side not only by having a different viewing angle but also in that a completely different model is projected. This means that upon tilting the optical device from the right to the left viewing position, the perceived model will switch between the three models associated with the three pixels. This can thus be used to provide scenes of more than one model from one and the same integral image device, which in turn opens up e.g. for different kinds of animation. This will be further discussed further below.

The concept of dividing the cell into pixels is of course not restricted to only three pixels and not only in one direction. The cell can be divided in any number of pixels and can be spread over the entire cell area. The practical limit is typically set by the size of the area which contributes to the image shown at the microlens at each instant. FIG. 2D illustrates a cell 24 divided into a large number of pixels 19. Each pixel 19 can be associated with a separate model. However, a number of pixels 19 may also be associated to a same model. In such a way, one can select the image or scene that is shown as a function of the viewing angle according to the whish of the designer. The pixels 19 in the embodiment of FIG. 2D are in the shape of close-packed hexagons. However, the pixels may have any shape and any packing structure, determined only by the needs of the particular application intended.

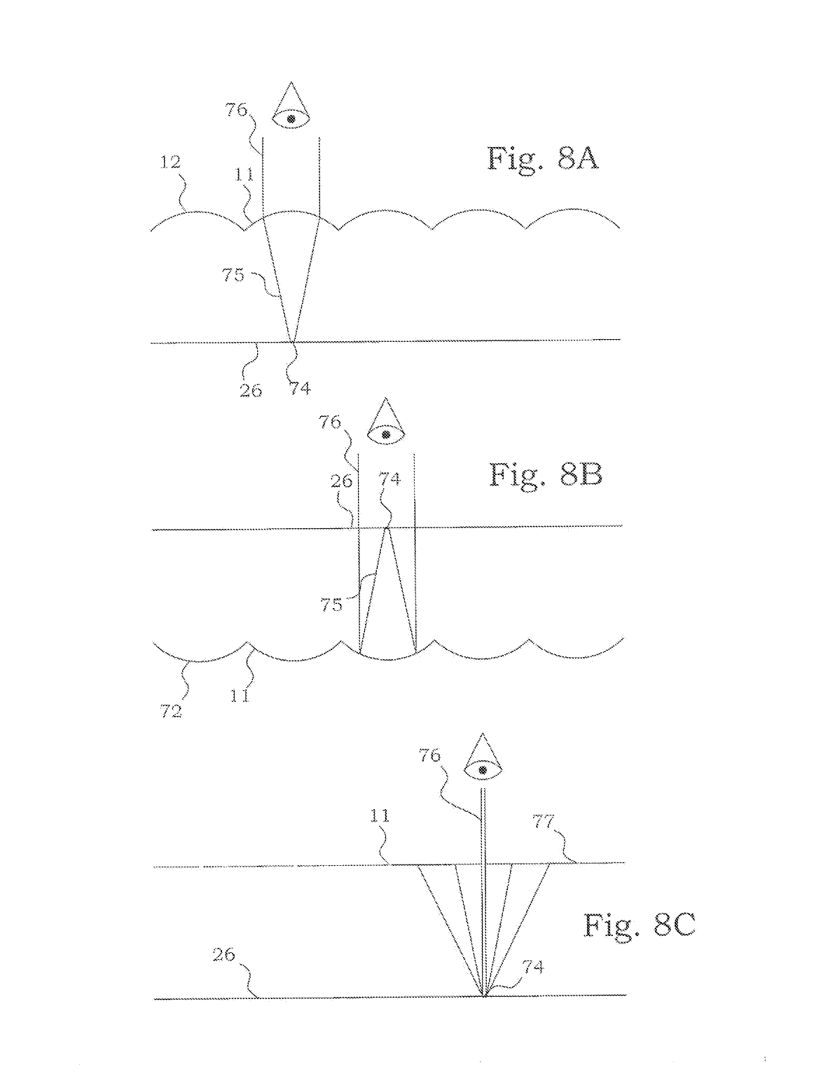

A method for manufacturing such an integral image device, which may be a composite integral image device, is schematically illustrated by the flow diagram of FIG. 9. The method for manufacturing integral image devices starts in step 200. In step 210, a set of digital model representations of a set of models to be visually perceived is defined. The set of models comprises at least one model. In step 212, a digital projection representation of the set of digital model representations projected onto a plurality of virtual cells in a virtual image plane is calculated. The digital projection representation of each virtual cell is calculated as viewed from a respective one of a plurality of projection origins. Each of the virtual cells has at least one pixel. Each pixel of the at least one pixel corresponds to an associated model of the set of models. The associated model is allocated in dependence of at least a direction of a projection line between the respective projection origin and the pixel in question. In step 214, the digital projection representation is modified for enhancing visual effects, such as depth contrast, edge contrast or intensity differences. This step may be omitted without removing the basic technical effect, but it is presently considered as a preferred embodiment to have it included. In step 220, structures are physically created in cells at an image plane of an integral image device. The structures correspond to the plurality of virtual cells. The cells are distributed according to an image array. The physical creation is controlled by the digital projection representation. Preferably, this step 220 comprises the step 222, in which a tool is formed based on the projection representation, and step 224, in which the tool subsequently is used to physically create the structures. In step 230, a plurality of focusing elements of the integral image device is physically created. The focusing elements are distributed according to a focusing element array. The image array and the focusing element array are created conform to each other. This means that they have the same array geometries and corresponding distances between neighboring elements in the array. Step 230 is illustrated as being performed after step 220. However, step 230 can be performed after, simultaneous with and/or before the step 220 and in particular step 224. Preferably, the steps 224 and 230 are performed as one and the same continuous manufacturing process. The procedure is ended in step 299. The different steps will be described more in detail further below.

A number of embodiments will be described here below. In order to illustrate the basic projecting operations as clear as possible, an embodiment having one pixel per cell is first used as a model example. In such an embodiment, the set of model typically comprises only one model, which will be used for all pixels and cells. Later, necessary generalizations into multi-pixel cells are described. The allocation of an associated model to a pixel then becomes trivial.

The model to be imaged can be based on a real object or a fictive object. The digital model representation of the model to be imaged can be defined in many different manners. For simpler objects, the surface and properties of the surface may simply be expressed as a mathematical function. This can be appropriate e.g. when the models to be imaged are composed by a limited number of relative simple surface structures, such as plane surfaces, spherical surfaces, cylindrical surfaces etc.

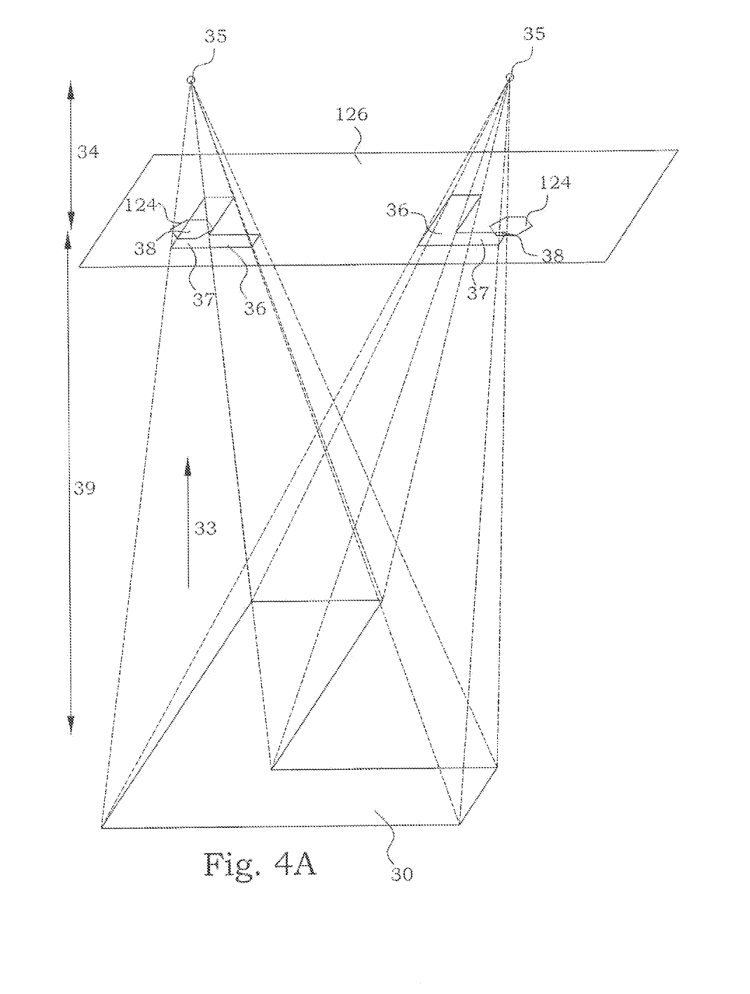

In cases where more complex objects are to be represented, other approaches can be selected. There are many different ways of representing a three dimensional model in a digital manner. In one embodiment, the surface of the object to be imaged is divided into small part surfaces, which in turn can be approximated by polygon planes. Each such part surface may thereby be represented by coordinates of the polygon corners or vertices and a definition how the vertices are connected, i.e. how the edges are positioned. A simple embodiment is illustrated in FIG. 3A, where an object 30 is approximated by a number of polygons 31. The used polygons are in the present embodiments all triangles. A triangle is fully defined by defining the three vertices 32 of the triangle and how they are connected. Instead of having to define an entire complex surface, the model reduces the required definition data to a set of triangle corner positions and associated edge information. In general, a finer division gives a more appropriate model. However, at the same time, the computational complexity increases. Therefore, typically a compromise between model representation accuracy and computational complexity has to be made.

In a more mathematical approach, it can be described as a vector based polygon representation. The 3D model is tiled using a number of polygons covering its surface. Each polygon is represented as a list of three dimensional coplanar corner points called vertices and the connectivity information of these, the edges. The edges thus defines an interior two-dimensional surface of some shape, located in the three dimensional space. Several of these surfaces can thus be put together to build an entire 3D model. For each polygon, its polarization will be noted as positive if the vertices are given in a counter clockwise order, i.e. in a right hand coordinate system, and negative otherwise. Being a 2D entity in 3D space, a polygon has two faces. It is convenient to adopt the notion that the polygon is facing the front, and thus being visible, if its normal is directed towards the viewer (or projection point). Thus a polygon is represented as a list of vertices:

P={v₁, v₂, . . . vₙ} (1)

where a vertex, vⱼ, is given as a vector in the three-dimensional space [symbol] ³. The polygon normal may be calculated as:

n_{P}=(vⱼ₊₁−vⱼ)×(vⱼ₋₁−vⱼ). (2)

j∈{1, 2, . . . n} is an index in the vertex list and x denotes the right hand cross product.

Another example of a model representation of an object to be imaged is to use “height curves”, as illustrated in FIG. 3B. The object to be imaged is cut by a set of parallel planes, and the set of contours 29 of the cuts is used as a model representation of the object to be imaged. Instead of describing a fully three-dimensional object, a set of two-dimensional contours 29 are used. This typically reduces the complexity of the object description.

Also other types of digital models of a three-dimensional object can be utilized in connection with the present invention.

In the present disclosure a “digital model representation” is defined to be the opposite of an analogue model. In other words, a digital model representation is a model defined in mathematical terms, based on numbers, vectors, mathematical functions etc. Similarly, a “digital projection representation” also describes the projection in mathematical terms, based on numbers, vectors, mathematical functions etc.

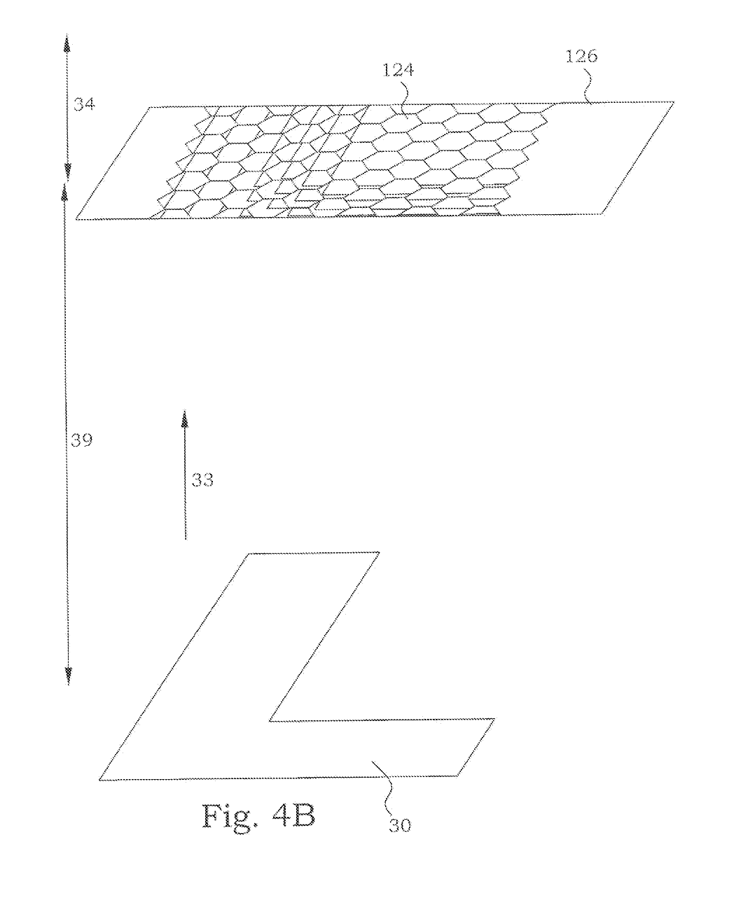

Once the digital model representation is defined, the process of calculating a digital projection representation of the digital model representation onto a plurality of virtual cells in a virtual image plane can be initiated. In this embodiment, where each virtual cell only comprises one pixel each, the allocation of an appropriate model becomes trivial, since the set of models only comprises one model. The digital projection representation is calculated as viewed from a respective one of a plurality of projection origins. In FIG. 4A, a very simple example is illustrated at the left side in order to explain the principles. In this case, the model, i.e. in this case the object 30 to be imaged is a flat polygon with six corners, forming an L-shaped body. As mentioned above, the projection assumes a projection origin 35 for each virtual cell 124. Typically, in the final integral image device, this projection origin 35 corresponds to the centre of curvature, if a spherical microlens is used as focusing element in the final integral image device. The object 30 to be imaged, or rather the digital model representation thereof, is projected as a projected object 36 onto a virtual image plane 126 with the projection origin 35 as reference point. The virtual image plane 126 is flat for most applications. However, in applications were sharpness at higher angles are requested, the virtual image plane 126 as well as the final real image plane can be curved, e.g. composed by spherically curved portions. The projected object can also be allowed to comprise structures having a depth extension, as will be discussed further below. Information can also be provided in different layers. The portions 37 of the projected object 36 that falls outside the virtual cell 124 in question are neglected and only the portions 38 situated inside the virtual cell 124 are considered, i.e. a “view-port” clipping of the projection is performed.

The magnification, i.e. the size relation between the projected object 36 and the original object 30 is determined by the distance 34 between the projection origin 35 and the virtual image plane 126 and the distance 39 between the virtual image plane 126 and the position of the object 30 to be imaged. If the object 30 has an extension in the projection direction 33, different parts of the object 30 will consequently be associated with different magnifications. In the present embodiment, since the object 30 is flat, the magnification will be essentially constant for all parts. The apparent depth of a certain point of the final image will, in case spherical microlenses are used as focusing elements, be equal to the distance between the projection origin and that point at the object model plus the radius of the spherical microlens curvature.

As briefly mentioned above, the cell in the final integral image device is typically situated below the focusing element to which it is associated, as seen in the thickness direction of the integral image device. However, in particular embodiments, at least parts of the cell may be situated “outside” the area covered by the focusing element as seen in the thickness direction. Corresponding properties are valid with respect to the projection origins 35 and the virtual cells 124.

Since the object 30 to be imaged is defined by a digital model representation, the projected object 36 is represented as a digital projection representation of the model. The calculation thus preferably uses the simplifications introduced by using a model representation instead of an entire object description. In the present embodiment, the virtual cell 124 is a hexagon and the portion 38 of the projected object 36 that is projected within that hexagon also forms a polygon. In this case, the remaining part of the projection is composed by a part of the left side of the “L”. By defining the positions of the corners or vertices of the polygons of the projected object 36 and the edges connecting the vertices, the digital projection representation is fully defined.

In FIG. 4A, one additional example is also illustrated at the right part. A new projection origin 35 is defined as well as a new virtual cell 124. In this case, the angle with respect to the object 30 to be imaged is changed and another portion 38 of the projected object 36 falls within the virtual cell 124. In this case, it is only the very tip portion of one of the legs of the “L”. The procedure is repeated for all virtual cells to be used.

The plurality of projection origins typically corresponds to the centre of curvature of the plurality of focusing elements in the final product. In a typical case, the different projection origins 35 are positioned in a plane substantially perpendicular to the projection direction 33. This will result in that if the final structures are aligned with the respective focusing elements, the final image can be seen when viewing the integral image device in directions relatively close to the normal of the surface of the integral image device. However, if the final integral image device is intended to be viewed in another angle, the plane of the projection origins can be adapted accordingly.

FIG. 4B is an illustration of a portion of the virtual image plane 126 when digital projection representations for all virtual cells 126 within that portion are calculated. One can here easily see that the total virtual image plane 126 does not present any regularly repetitive patterns.

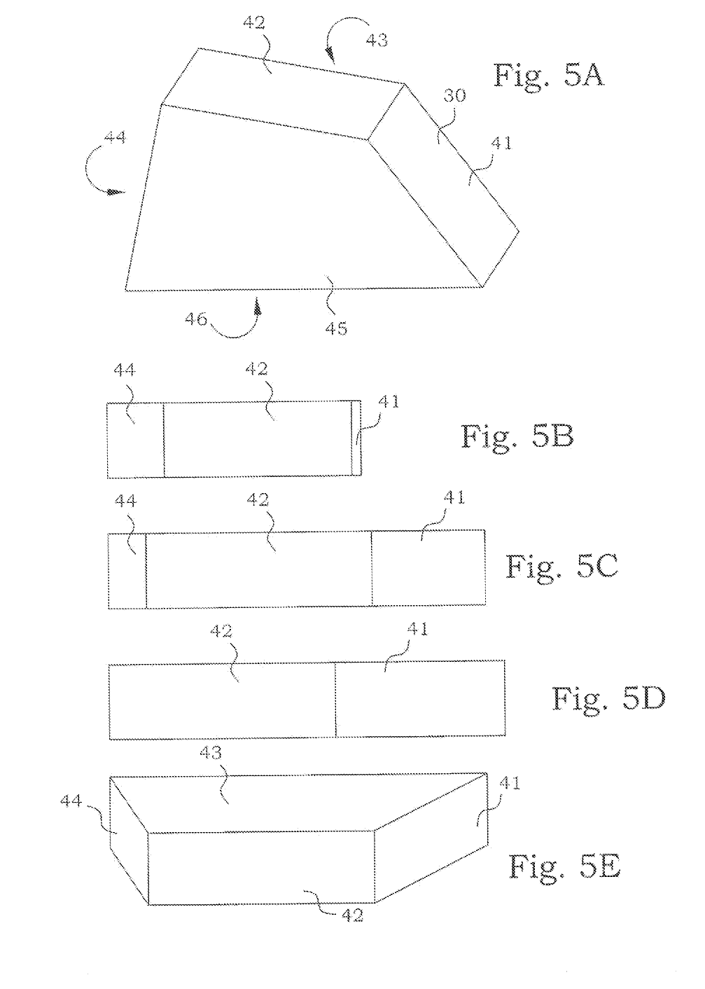

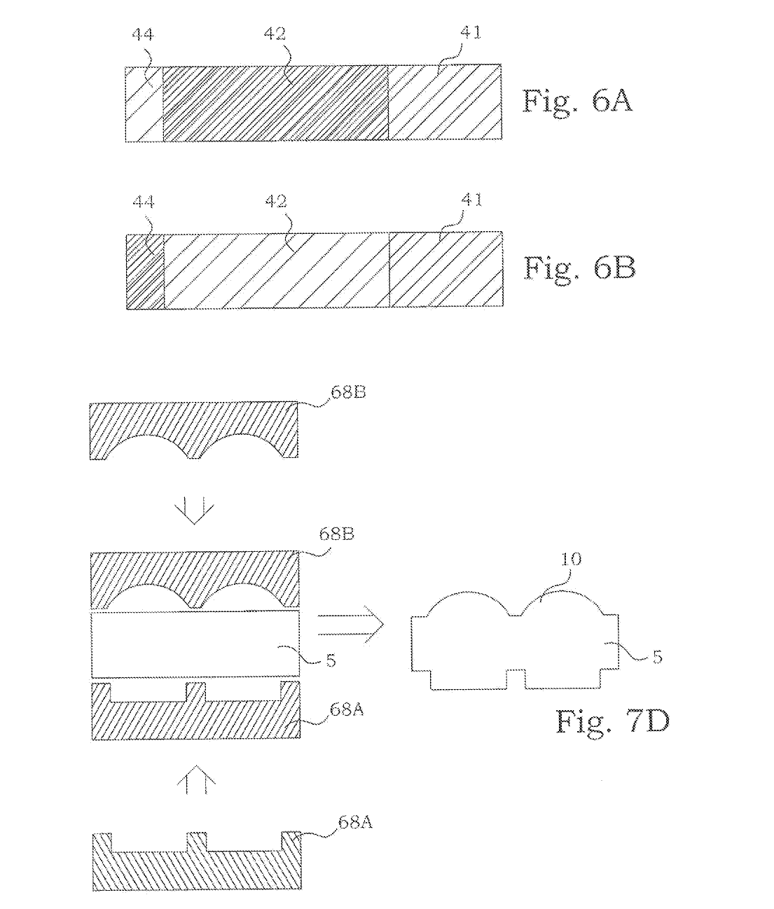

The embodiment in FIGS. 4A and 4B shows a very simple object in order to explain the projection principles. The object is totally flat and does not present any three-dimensional structure. However, the present procedure also operates, and is in fact most useful, for objects having an extension also in the depth direction. FIG. 5A illustrates an elevation view of a simple such three-dimensional object 30 having a number of surfaces 41-46. Such an object is thus still simple enough to be defined by a set of totally six polygons.

The projection principles as presented further above are easily extendable also to three-dimensional objects. However, in such a case, one has also to consider whether a certain surface is hidden behind other surfaces or not. FIGS. 5B-E illustrates the object 30 of FIG. 5A as seen from different directions. Different surfaces 41-44 of the object 30 can be seen from different projection origins. FIG. 5B illustrates the object when viewed from the left, FIG. 5C from almost straight above, FIG. 5D from the right and FIG. 5E somewhat from behind. The projection will therefore considerably change its appearance depending on the viewing angle. The digital projection representation for each virtual cells for such an embodiment presents a set of polygons, each of which representing a specific side of the object.

The method can be further extended to general three-dimensionally shaped objects. If a digital model is based on areas defined by polygon planes, the generalization is straight-forward. The calculation of a digital projection representation comprises the calculation of a digital projection of corner points of the polygon planes and associating each area defined by the projected corner points with an original plane direction of a corresponding polygon plane.

A more detailed embodiment of such a projection process is described here below. Now, assume a three dimensional mesh model representation, where each polygon is represented as a list of vertices in positive polarization. The task is to compute how this 3D shape will look when imaged from a projection point and within a virtual cell. This process is typically referred to as a projection. The three dimensional image of a polygon can be transformed, analogue to as being viewed through a lens optical properties, and imaged in the cell in the virtual image plane. This is somewhat in analogy with a camera taking a picture of the real world and giving a two dimensional photograph. In reality, when performing this task in the digital regime, there will be a few physical factors that one would have to take into consideration that limits this analogy. The lens and the cell will form a system with certain properties. The lens will have a certain magnification factor, deciding how large (or small) the object features will be. Moreover, the cell size will limit the field of view (FOV) of the system. Object features outside the FOV will project outside the cell, and thus not be visible. The size of the lens opening will act as an aperture, regulating the amount of light that is allowed in the system, and thus the depth of field (DOF). The DOF is the range where objects are in focus for a camera. These factors will need to be handled during digital rendering. The FOV causes object features lying at a too steep angle to the image plane to be imaged outside the cell boundaries. If not handled they will “leak” onto neighboring cells and thus destroy the pattern. This can be handled by a process called view port clipping where by the parts of a polygon sticking outside the cell boundaries are cut away—or clipped—thus forming a new shape. The DOF is mostly a limiting factor for the physical 3D viewing capabilities of the foil. For our construction purposes we will assume a pinhole aperture model, guaranteeing an infinite depth of field. While this does not confirm to the imaging model of the lenses, the difference is small, and the image should still be sharp within the physical depth of field. That leaves the magnification of the lens, usually described the focal length. This part can be integrated in the polygon projection process.

The projection of the mesh polygons transforms them in a non linear way. In addition, the fact that a three dimensional structure is imaged on a two dimensional plane leads to a situation where several polygons may be projected on top of each other. In reality this situation is handled in a natural manner. The closest surface is the one considered as visible. In a computer simulation however, this fact must be handled by determining which polygon is closest to the spectator. If the overlap is only, partial clipping has to be performed. The steps needed to perform rendering for a single cell are outlined below. There are five main steps performed; depth sorting, projection, view port clipping, depth clipping, and polygon distancing.

As outlined above, correct depth visibility from the projection origin must be guaranteed. Thus the algorithm must in some way make sure that the correct depth order and individual occlusion of the polygons in the 3D object is preserved. A depth sorting is thereby useful. For this, a variant of painter's algorithm can be employed. This is a straight forward technique where one starts with the object furthest from the observer (the cell) first, and then “paints over” with successive polygons that order. Thus, a polygon set M is first arranged in inverse order to the individual polygon's closest distance to the center of the cell.

After transforming the polygon to the cell center coordinate system, assuming that the xy-plane coincide with the cell plane, projection is performed to each of its vertices. A general projection matrix is dependent on several factors, but for the present embodiment it is only necessary to consider the following perspective projection; dividing the x and y coordinates of a vertex by its z coordinate, creating the effect of distance foreshortening; and multiplying by the focal length to account for magnification.

Thus from a vertex v∈P, where the polygon P∈M, a projected two-dimensional vertex u∈Q is constructed as:

$$u = [ \begin{matrix}{v}_{x} \frac{f}{{v}_{z}} \\ {v}_{y} \frac{f}{{v}_{z}}\end{matrix} ] , \qquad ( 3 )$$

where f is the focal length of the imagined lens.

Given the finite size of the cell, it is natural that parts of the projected polygons will fall outside its boundaries. If the whole polygon is outside it may be directly discarded, if not however, it needs to be clipped into one or more new polygons where it is intersected by the cell border, so-called view port clipping. The parts lying inside the cell are kept and the parts lying outside are discarded. In order to perform the clipping process the present embodiment uses the hidden surface removal algorithm by K. Weiler and P. Atherton “Hidden surface removal using polygon area sorting”, SIGGRAPH Comput, Graph., 11(2):214-222, 1977. The implementation is faithful to the algorithm described in the reference.

Depth clipping needs to be performed in order to guarantee that partially occluded polygons are visible, and divided up in to new ones. The depth sorting guarantees that the polygons are rendered back to front, however, a projected polygon may fully or partially overlap the already existing polygons in the projected plane. Thus, the already projected polygon is clipped to a new one. The result will be one or more polygons with a “hole” for the new one cut out. The depth clipping algorithm may be performed as one variant of view port clipping.

As an option, distancing of individual polygons can be performed. The distancing is beneficial in order to guarantee an integral image device that is compatible with the printers used in certain embodiments of later manufacturing steps. Each individual 2D polygon in the virtual cell needs to be separated from its neighbors by at least a distance Δ_{d} in order to avoid errors. In order to achieve this, the projected polygon is enlarged before depth clipping. This guarantees that the space left out is Δ_{d} larger than necessary. After the depth clipping the original projected polygon is again added to this space. The resize process can not be performed simply by scaling the polygon. This approach will for instance fail for concave polygons. In stead it must be made sure that each vertex is moved so that the distance between the new and old edges are exactly Δ_{d}. Using this fact and constraining the shape of the polygon, each vertex can be moved along the normals of two meeting edges.

When making the pure projection into a completely flat image plane, some information about the original object is lost, namely the information about the “direction” of each surface, e.g. each polygon. In the two-dimensional embodiment of FIG. 4A-B, this was not an important issue, since all original surfaces were directed in the same direction. However, in the three-dimensional case, the direction of the planes may differ considerably. In some application, for instance for images having distinct edges, this is not a severe problem. However, for rounded-off images, it might be difficult to experience the full three-dimensionality in the final picture.

To a certain extent, it is possible to let the projection have a certain depth. In most integral image devices, the structures that together form the image have typically a certain extension also in the depth direction. The structures may e.g. be embossments filled with color or not or printed ink with a certain thickness. This extension will also in reality give a certain depth impression. In cases where the structures can be given a depth profile on purpose (see embodiments further below), this can be utilized for creating directed surfaces. Structures looking somewhat like Fresnel lenses may be used to give a “fractured” directed surface.

If using e.g. the model approach of approximating the object with a set of polygons, some direction information is preserved if the original model of the object is made with the constraint that each polygon should have the same area. After projection, a polygon that is tilted with respect to the projection direction will have a smaller projected area than a polygon that is perpendicular to the projection direction. This means that the polygon borders in the projection will appear closer in parts of the object that are tilted.

One other possibility is to modify the representation of the projection for enhancing depth contrast. One approach would be to superimpose a pattern onto the digital projection representation. The pattern could e.g. be a point raster, lines or other relatively discreet pattern, preferably provided in a random fashion. The (average) density of the pattern may then be adapted, increased or decreased, according to the actual direction of the surface portion in question. The reference direction could be the direction of intended view, i.e. the projection direction, but could also be selected to any other direction. In such a way, an illumination of the object from a certain direction can be simulated. The addition of the pattern will then add a shadowing on areas corresponding to sloping surfaces in the object. As will be discussed more in detail below, some embodiments of an integral image device will give rise to a lighter perception from structures compared to the background, whereas other embodiments of an integral image device will give rise to a darker perception from structures compared to the background, depending on the actual embodiment of the production method. When performing the calculation of the digital projection representation and possible modifications thereof, concerns about such relations also have to be considered, i.e. one has to decide what is going to appear as light or dark in the final image.

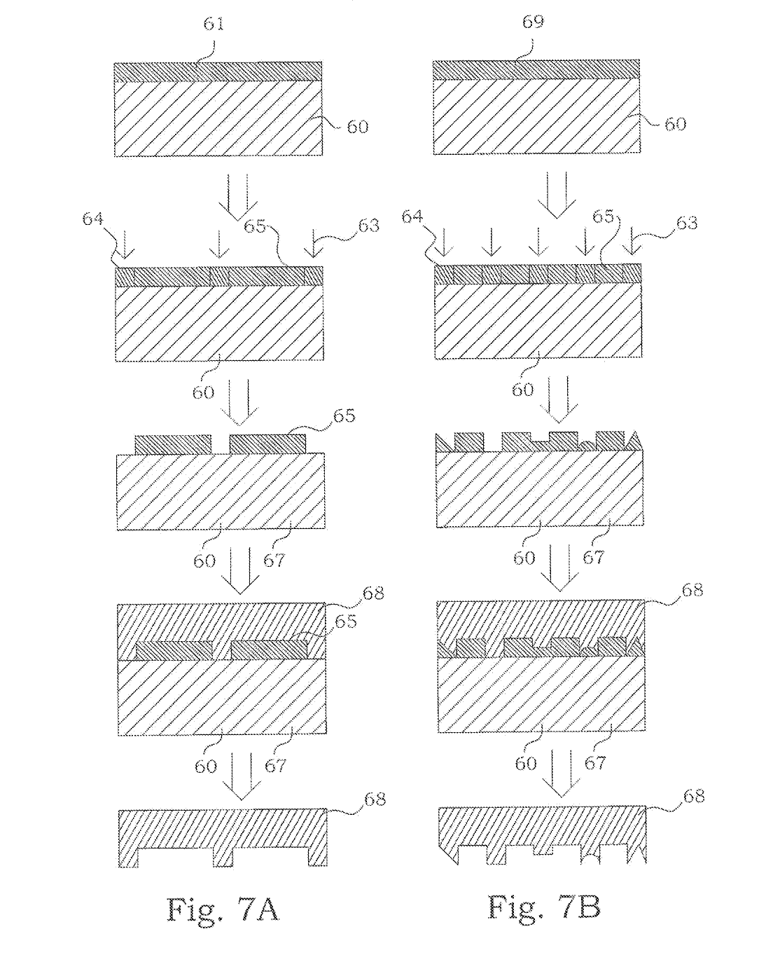

FIG. 6A illustrates one example of a modified digital projection representation of an object similar to the one of FIG. 5A. In this embodiment, edges or structures in general will appear as lighter than the background in the final device, and an illumination from above is assumed, i.e. no particular shadowing effects are present. The middle surface has a normal that is almost parallel to the direction of the illumination. That surface is therefore given an additional irregular line pattern with a high density, which means that the surface in the final image will appear bright. The surfaces at the sides are instead directed with their normals forming a large angle to the illumination direction and the density of lines is therefore lower. These sides will therefore appear as less bright than the middle surface. FIG. 6B illustrates another example of the same object, but now with the assumption that a structure will give rise to a dark perception in the final image. Therefore, in this embodiment, the middle surface is given a low density of lines whereas the side surfaces are given a higher density of lines.

The most important parts of an object for perception of a depth in an image are edges. In one embodiment, a modification of the digital projection representation is performed to enhance a contrast at edges in said projection. This can e.g. be performed by artificially introducing additional “edges” very close to a true edge. The edges will then in the final image be perceived as one edge with a higher contrast and with a broader apparent line width.

It is also sometimes beneficial to modifying the digital projection representation also for other purposes. One example is e.g. to adapt intensity differences. In certain integral image devices, embossed structures are provided at the image plane. In order to enhance the possibility to distinguish the structures, they can e.g. be filled with ink or paint. In such cases, it is sometimes difficult to obtain a uniform coloring level over relative large area recesses. For assisting in achieving a uniform coloring level, small structures, typically too small to influence the overall perception of the model, are introduced to interrupt large areas recesses. The small recess interruption structures do themselves not contribute to the color, which means that the maximum mean coloring level is lowered somewhat. However, this can also be utilized in order to adapt a coloring level by selecting a certain density and size of the recess interruption structures.

Also the surface direction itself gives a certain intensity effect. A steep slope gives typically a higher intensity than a shallow slope. By adapting the actual slope in the digital projection representation, a modification of the intensity can thereby be achieved.

If coloring is combined with embossed structures, a shallow structure with varying depth can be filled with color or ink. If the depth is shallow enough or the ink or color transparent enough, this can give rise to intensity variations.

In cases where contrast and/or colors are requested, diffractive properties can also be utilized. The structures could thereby be constituted by diffractive structures. The separation between such diffractive structures then determines the color and contrast properties of the integral image.

The above discussions concerning cells having a single pixel and projection of only a single model can easily be generalized to give more freedom of design for the final visual perceptions of scenes. If one refers back to FIG. 2D, it is easy to realize that the above process for the single pixel approach can be applied to each pixel area instead of to the entire cell area. A model is selected and a projection is made, which is limited to the pixel area instead of to the cell area. The neighboring pixel is then not necessarily associated with the same model, which means that for a neighboring pixel, the modeling and projection can be performed for another model. A final scene as seen from the integral image device is then composed by the integral perception of structures within one pixel of each cell. The total number of models that can be visible by a viewer over an entire surface of an integral image device is then in theory only limited by the number of pixels in each cell. In practice, the uncertainty of the viewing position and registration accuracy of the structures within the pixel may restrict the number of distinguishable models.

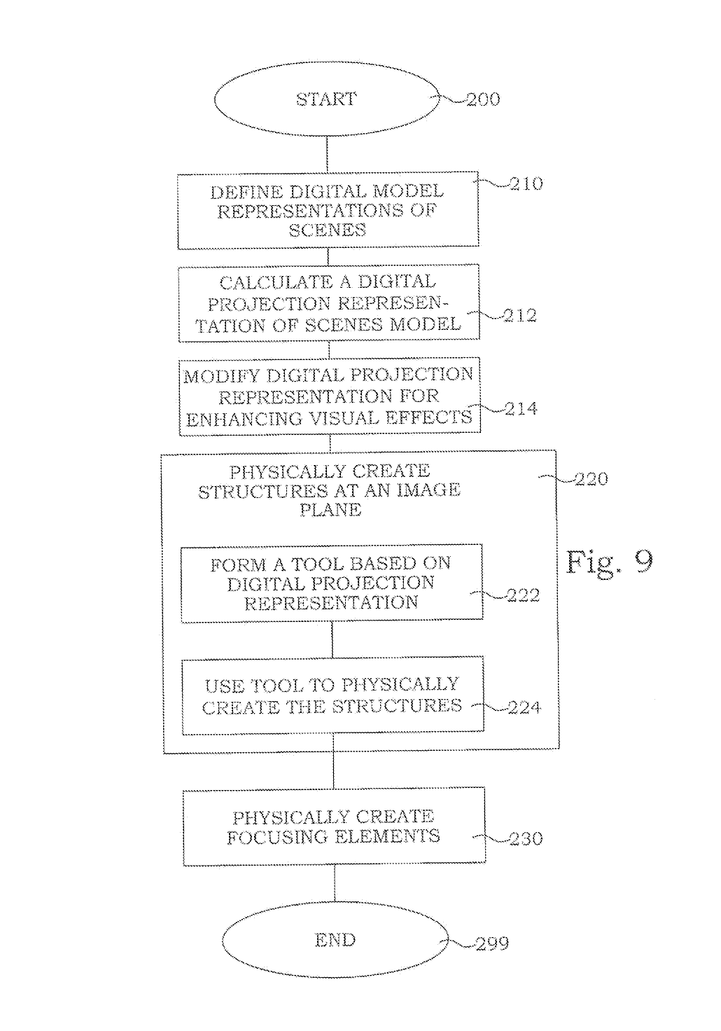

The models to be associated with the different pixels are typically allocated in dependence of a direction of a projection line between the respective projection origin and the pixel in question. In one embodiment, the assumed viewing distance can be approximated to be equal to infinity. In such a case, it is assumed that the viewer perceives light rays exiting the focusing elements in the same angle irrespectively of where on the surface the light rays are passing the focusing elements. In such an embodiment, the models to be associated with each pixel are typically allocated in the same manner in all cells over the entire image plane. This situation is schematically illustrated in FIG. 10A. The assumption is in other words that when viewing the integral image device from a relatively large distance, the same position in every cell contributes to the perceived scene. This is approximately true for relatively limited device sizes, where the lateral dimensions typically are much smaller than the distance between the viewer's eyes and the device. The allocation of the model is then directly dependent on the direction 9 of a projection line between the respective projection origin 35 and the pixel 19 in question, since this corresponds to the intended viewing direction for all focusing elements.

For applications, where the angle of view differs between different positions at the integral image device, the allocation of models can be adapted for another specific viewing point with respect to the integral image device. This is schematically illustrated in FIG. 10B. The viewing angle for a ray 17A passing a focusing element at the right part of the device is different from a viewing angle for a ray 17C passing a focusing element at the left part of the device. In order to have both the focusing elements showing the same model, the allocation of models has to be adapted accordingly. The allocation of the model is in this case dependent on the direction 9 of a projection line between the respective projection origin 35 and the pixel 19 in question as well as on the relative geometry between the intended point of view and the focusing element corresponding to the cell. The allocation will therefore be different for different cells.

In the illustrated example of FIG. 10B, the same model is to be allocated for the illustrated marked pixels 19. The dependence of the direction 9 of the projection line has to be adapted based on the lateral position x, y, of the corresponding focusing element 12 with respect to a reference point 7 and an intended viewing distance z. That is, the allocation of an associated model to a pixel is performed dependent on the direction 9 and in further dependence of an intended viewing direction between an intended viewing position and a focusing element corresponding to the cell of the pixel.

The same kind of reasoning can also be used to create projections that are intended to be used on a curved image plane. The allocation of an associated model to a pixel can then be dependent on the direction 9 as well as on the intended final curvature of the image plane. Scenes, intended to be viewed from a curved integral image device can then be produced, in analogy with the co-pending application SE0850081-1.

The figures are only illustrating a two-dimensional view of this relation. However, anyone skilled in the art realizes that in reality, the direction 9 is a direction in a three-dimensional space, determined e.g. by two angles relative a normal to the image plane. The adaptation of this direction 9 in case of a non-infinite viewing distance than has to take the lateral position in two dimensions into account.

Some benefits of having cells with multiple pixels have been indicated further above. Since different models are visible for a viewer at different angles, i.e. in different scenes, this can be utilized in many respects. First of all, the total information storage capacity of an optical device of this type is increased. Instead of providing scenes of only one model, a multitude of models are possible to present at different scenes. It is furthermore possible to also utilize similarities between adjacent models, since the human eye is well adapted for providing integration not only in space but also in time. By having adjacent scenes of models that are similar but not identical, different types of animation can be provided. By tilting the integral image device in a certain direction or along a certain path in the angle space, the models may together form a moving image perception or may give rise to separate models in a predetermined order.

One particular application of this feature could be to provide a coding possibility. If a “message” is hidden in an integral image device as a certain model sequence, a key to the code could be a definition how to move the integral image device relative to a viewer or registration device. In other words, by moving the point from which the integral image device is viewed according to a predetermined angle path, the structures available at the image plane of the integral image device corresponding to the model representations will be shown in a particular model sequence. Such codes could be used e.g. for authentication purposes. If the predetermined angle path is a secret between the provider and the receiver, a correct detected model sequence can function as a verification of the origin of the integral image device or physical object connected thereto.

The above calculations and modifications may become quite complex for systems having very high numbers of cells and for complex objects. To perform such processing, very high computational power is typically needed. This is particularly true if cells with more than one pixel and if more than one model is used. Special hardware and software is typically needed, configured according to prior art knowledge within the respective technology branch. Furthermore, if a master for creating large surfaces, e.g. A4 or larger, comprising unique patterns, is to be produced, not only powerful calculations are needed; there is also a need for a laser writer capable of handling extremely large data quantities, e.g. 100 Gb or more.

After calculating the digital projection representation and possible modification thereof, digital data defining a requested image plane in the real world is available. The next step in the manufacturing process is to transfer this digital data into real physical structures at real image plane of an integral image device.

The most straightforward approach to perform this transfer is to directly control a means for creating structures at the integral image device based on the digital projection representation. For instance, a printing device can be controlled to plot the required structures directly onto integral image devices according to the digital projection representation. Commercial ink jet printing devices can already today provide structures with very high resolution, in some cases better than 50 μm. Such spatial resolution may be sufficient for some applications. The resolution is also believed to be further improved in a near future. The digital projection representation can thereby be used to control the ink jet printing device.

However, ink jet printing is a relatively slow and expensive process for purposes of mass production. Another approach, better suited for mass production, could instead be to form a tool based on the digital projection representation. The tool can then be used in a subsequent mass production step to form the actual structures at the image plane. Since the creation of the master tool is a step that only has to be performed once, both slow and relatively expensive approaches for tool creation may anyway be of interest.

In one embodiment, an embossing tool is formed. Geometrical structures are then created in the tool surface, depending on the digital projection representation. The geometrical structures are then complementary structures to the ones that are requested to be embossed into the final product. A protruding part at the tool surface will give rise to a recess in the embossed surface and vice versa. However, since these structures typically are to be viewed from the opposite side in the final product, the geometrical structures at the tool surface will look like the structures that finally are viewed. The embossing tool is then used in a successive step embossing geometrical structures into e.g. a polymer film.

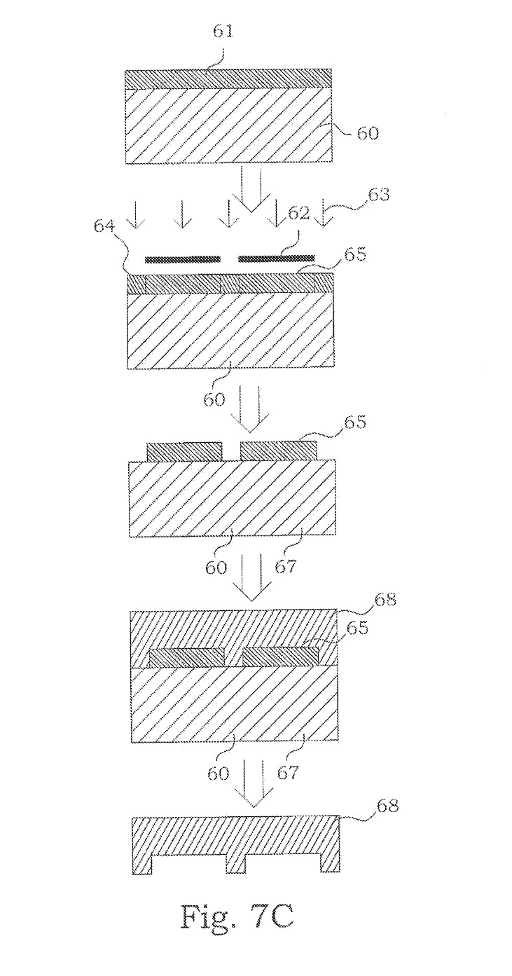

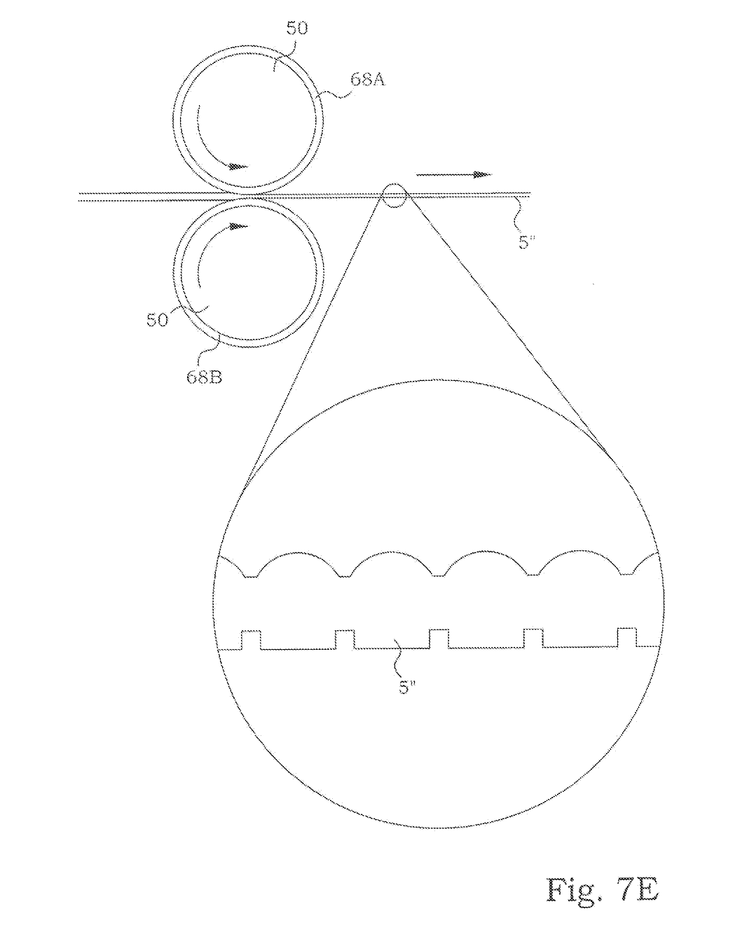

FIG. 7A illustrates one embodiment of such a tool forming step. The described embodiment is based on mastering then followed by replication through an embossing process. A substrate 60 is covered by a photoresist 61 by ordinary spinning methods. A laser writer equipment is controlled, based on the digital projection representation, to illuminate 63 only certain areas 64 of the photoresist 61. Areas 64 exposed to the irradiation undergo a chemical alteration which makes the photoresist in these areas possible to remove by solving procedures. In alternative embodiments, the photoresist 61 may have the property of being cured when illuminated, whereby instead the areas 65 that are not illuminated can be removed by solving procedures.

The required geometrical structures are thus formed directly by the remaining areas 65 of the photoresist, forming a master 67 for the geometrical structures. The master 67 is used for fabrication of a replication tool 68. In a presently preferred procedure, a seed layer is sputtered on top of the master 67, followed by an electroplating with Ni, forming a respective rigid replication tool 68 with a complementary shape to the master 67. The master 67 is then removed, e.g. etched away, leaving the replication tool 68. The tool 68 can in turn again be copied by electroplating with Ni to save a master tool for manufacturing of future spare copies. The tool surface may be treated for e.g. anti-sticking purposes or hardening. Other procedures to form a replication tool 68 from a master 67, known in prior art, can be utilized as well.

FIG. 7B illustrates another embodiment of a tool forming step that can be used in the present invention. A substrate 60 is covered by a surface coating 69 that is possible to be removed by laser ablation. The coating can be performed by ordinary spinning methods or any other surface coating methods suitable for the surface coating 69. A laser writer equipment is controlled, based on the digital projection representation, to illuminate 63 only certain areas 64 of the surface coating 69, in analogy with the previous embodiment. However, the laser illumination now gives rise to an ablation of the surface coating 69. By controlling the position as well as the intensity or time at each position, geometrical structures can be formed in the surface coating 69, which geometrical structures can present different depths with reference to the surface of the original material film. A master 67 having more than two distinct heights can thus be produced.

The creation of the actual tool can then follow the same procedures as described above or in any other way known by anyone skilled in the art.

FIG. 7C illustrates another embodiment of a tool forming step that can be used in the present invention. A substrate 60 is covered by a photoresist 61 by ordinary spinning methods. A mask 62 is produced, e.g. by letting a laser writer write a pattern in a photoresist layer provided on top of a Cr covered glass plate, based on the digital projection representation. The illuminated photoresist is removed and the uncovered Cr is etched away. Alternatively, for negative photoresists, the non-illuminated photoresist is removed and the uncovered Cr is etched away. The remaining photoresist is subsequently also removed, leaving a mask with a Cr pattern at a glass plate. Other mask production methods according to prior art can also be used. The mask 62 is provided to cover the surface of the photoresist 61. The substrate 60, photoresist 61 and mask is irradiated by ultraviolet light 63″, inducing a chemical alteration of the uncovered parts of the photoresist 61. The rest of the procedure follows the same basic principles as described in connection with FIG. 7A.

If the step of physically creating structures corresponding to the plurality of cells is performed by use of an embossing tool, it is typically also convenient to perform the step of physically creating a plurality of focusing elements by use of an embossing tool. The principles of creation of such a tool can by advantage be made in analogy with any of the above embodiments. However, the requested structures are now the array of focusing elements. In the embodiments using development of the photoresist, an additional step is typically used. When the photoresist is developed, areas of photoresist remain on the surface, corresponding to the required positions of the microlenses. A typical manner to proceed is to heat the substrate until the photoresist melts. Due to surface tension, essentially spherical volumes are formed. These spherically formed structures can then be used as a master in analogy with the procedures described above.

Microlenses may also be formed directly by a laser writer.

As illustrated in FIG. 7D, when replication tools 68A, 68B of both the microlens array and the array of geometrical structures are available, they are placed on opposite sides of a polymer foil 5. By applying appropriate pressure and temperature over the assembly, the polymer foil 5 will be embossed by the requested structures. In this stage, the alignment of the two replication tools is very important indeed. A relative rotation alignment between the symmetry axes of the arrays is typically requested to be much better than 0.01 degrees not to impose significant deterioration or rotation of the image, and preferably, the replication tools should be aligned to be essentially parallel. Larger appearing depths are more sensitive to rotational errors. In certain applications where rotations of the final image is not critical, and in particular when small appearing depths are used, the rotation alignment can be allowed to be 0.05 degrees, in some applications as high as 0.1 degrees, and in some applications even higher.

A misalignment between the image plane and the focusing element plane basically results in two effects. First, the position of the object to be viewed shifts in position on the integral image device. Secondly, the field of view in which the intended cell can be seen through the respective focusing element is turned. When the view direction becomes large enough for the focusing element to imagine a structure from a neighbor cell, a “flip” or “jump” in the viewed scenes occurs. When there is a misalignment, this “flip” will occur at smaller angles than if a perfect alignment is used. Therefore, in applications where the requested viewing angle is perpendicular to the surface of the integrated image device, linear misalignments should preferably be kept below 10% of the width of the cells, more preferably less than 5% of the width of the cells and most preferably less than 5% of the width of the cells. When the replication tools are removed, an optical device 10 according to the present invention is available. However, one should also be aware of that e.g. a flip can in certain applications be used on purpose for achieving certain visual effects.

In a preferred embodiment, the replication is performed as a continuous manufacturing process. To that end, as illustrated in an embodiment of FIG. 7E, the replication tools 68A, 68B are provided at cylinders 50 on opposite sides of a continuous web 5″ of polymer foil. Also here, it is of crucial importance that the alignment between the microlenses and the structures is very accurate.

In a presently preferred embodiment, as illustrated in FIG. 7F, the continuous manufacturing process comprises UV embossing into irradiation curable polymers provided at a substrate foil. A substrate foil 80 is provided from a non-shown reel. A first replication tool 68A is arranged at a cylinder 50. A first applicator 81 is arranged for application of a layer 82 of an irradiation curable polymer via the surface of the cylinder 50 onto one side of the substrate foil 80. The first replication tool 68A at the cylinder 50 will thereby create structures in the layer 82 of the irradiation curable polymer and the substrate foil 80 is brought in contact with the cylinder 50, using a pressure roll 84. A UV radiation source 83 is provided to cure the curable polymer layer 82, preferably before leaving the contact with the first replication tool 68A. A peeling roll 86 assists in separating the cured polymer from the first replication tool 68A. The same procedure is repeated for the opposite side of the substrate foil 80. A second applicator 81 is arranged for application of a layer 85 of an irradiation curable polymer via a second replication tool 68B onto the other side of the substrate foil 80. The second replication tool 68B is arranged at a cylinder 50 and will create structures in the layer 85 of the irradiation curable polymer, and the substrate foil 80 is brought in contact with the layer 85 at the cylinder 50. A UV radiation source 86 is provided to cure the curable polymer layer 85, preferably before leaving the contact with the second replication tool 68B. The quality of the final product in terms of e.g. alignment can be controlled e.g. by arranging a monitor 87 to analyze the final product. Feed-back information can then be provided to the control of e.g. the cylinders 50 to compensate for imperfections. In this way, a continuous web 5″ of a polymer foil stack is produced, which comprises a central substrate foil covered with cured polymer coatings at each side, in which microlenses and geometrical structures are embossed.

In another embodiment of the step of physically creating structures corresponding to the plurality of cells, a tool in the form of a printing plate is formed. Geometrical structures are then created in the printing plate, depending on the digital projection representation. The protruding geometrical structures in the printing plate correspond to the requested geometrical structures at the final product. The printing plate is then used in a successive step printing geometrical structures onto e.g. a polymer film.

The printing plate can be manufactured in an analogue manner to the embossing tool described further above, e.g. utilizing well known methods.

The actual printing could be performed before, simultaneous as, and/or after the step of physically creating a plurality of focusing elements of the integral image device.

In a further embodiment, intaglio printing can be utilized. In such a process, the print in itself will give rise to geometrical structures at the same time as color can be provided. A similar setup as in FIG. 7F can be utilized for intaglio printing. In such a modified setup, the layer 82 is exchanged for print, filling the structures of the replication tool 68A. By removing the excess amount of print before the replication tool 68A is brought into contact with the substrate foil 80, e.g. by a scraper and/or polisher, a layer of print is provided onto the substrate foil 80. The print layer is typically non-covering. It may then also be optionally possible to fill the non-covering parts with another color.

An embodiment of an integral image device according to the present invention thus comprises a polymer foil stack of at least one polymer foil. A first interface of the polymer foil stack is an image plane comprising structures in cells in an image array. The structures correspond to a digital projection representation. The digital projection representation is calculated as a set of digital model representations projected onto a plurality of virtual cells in a virtual image plane. The digital projection representation of each virtual cell of the plurality of virtual cells is calculated as viewed from a respective one of a plurality of projection origins. The set of digital model representations is a definition of a set of models to be visually perceived. The set of models comprises at least one model. Each of the virtual cells having at least one pixel, and each pixel corresponds to an associated model of the set of models. The associated model is allocated in dependence of a direction of a projection line between the respective projection origin and the pixel in question. The optical device further comprises a second interface of the polymer foil stack. The second interface has focusing elements in a focusing element array. The focusing element array and the image array are arranged in conformity with each other.

The models can generally be of any kind of visually perceived model. Particularly useful is the integral image device if at least one of the virtual cells comprises pixels associated with different models. With the present approach, it is also possible to provide integral image devices where at least one model of the set of models comprises three-dimensional objects. Furthermore, also with the present approach, it is possible to provide integral image devices where at least one model of the set of models comprises parts that are non-repeated.

The quality of an integral image of an integral image device according to the above described principles depends on a number of factors. The resolution and registration of the structures of the cells is one factor. This is mainly dependent on the resolution and registration of the master structure. Another factor is the accuracy and registration of the operation of the focusing element. Furthermore, the lateral size of the cells does also influence the final image quality. A general trend is that, the smaller cells and thereby larger number of cells the better are the possibilities for achieving high quality images. With considerations of the operation of the human eye, it is preferred if the cells has a largest diameter of less than 200 μm, preferably less than 100 μm.

Another limitation is set by the applications. In most cases, the thickness of the integral image device typically is a non-wished property, and in general, the thinner the device is, the easier is the use in most applications. However, if the thickness becomes so small that the integral image device has difficulties to maintain a sufficient flatness, there might be problems during manufacturing. Presently, it is preferred to have an integral image device comprising a stack of at least one polymer foil, where the stack has a thickness of less than 500 μm and preferably less than 50 μm.

The foil or stack of foils can advantageously be utilized as security markings. The foil or stack of foils can then be applied onto or incorporated into various substrates to further increase the level of security. It is then a benefit if the foil or stack of foils can be very thin. One particular example of such an application could be a so-called windowed security thread, where the foil or stack of foils is woven into a substrate, normally a bank note, an identification document or a security document.

Not only lateral alignment is of importance. Also the accuracy in the thickness is of importance. The focusing elements have a best imaging plane, and structures appearing in front of or behind that best imaging plane will not be imaged with the optimum resolution. If a large magnification is utilized, a small spot at the image plane is preferably selected by the focusing element. The best imaging plane is in such a case situated close to the focal plane of the focusing element. For an infinite magnification, the best imaging plane coincides with the focal plane. If a smaller magnification instead is utilized, the area that is imaged by the focusing element is larger, and the best imaging plane is situated further away from the focal plane. From this it can be concluded that each magnification has its own optimum foil thickness for a certain set of focusing elements.

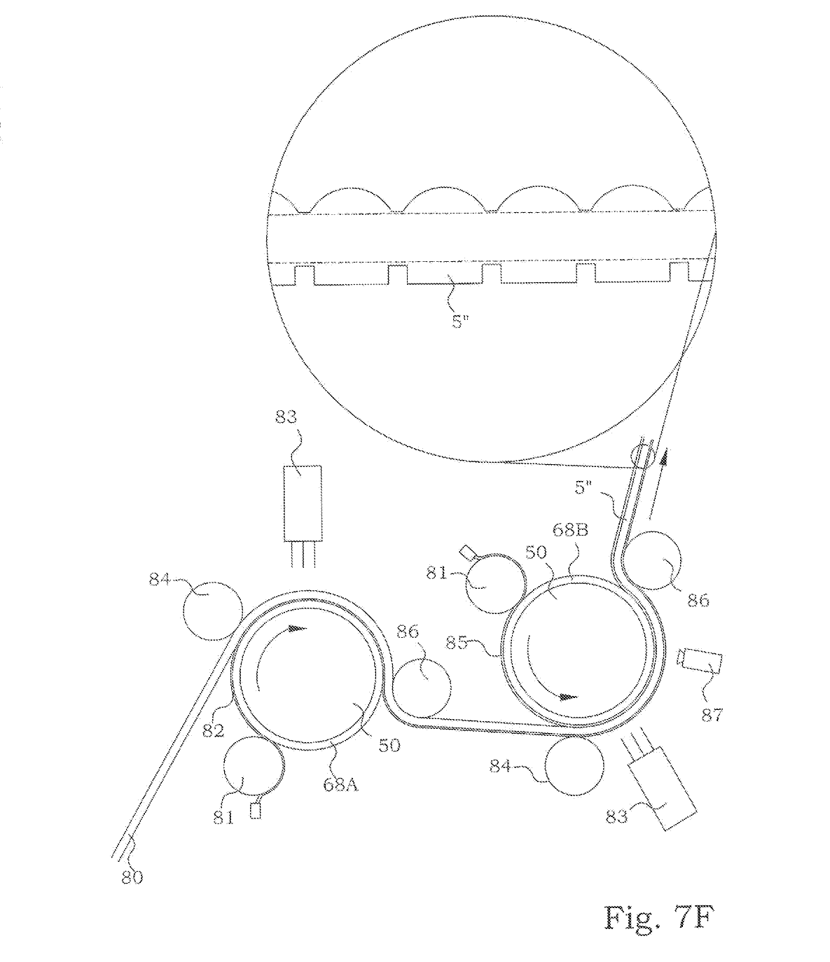

In the above examples, microlenses have been used as examples of focusing elements. However, also other types of focusing elements, such as curved mirrors or simple apertures can also be utilized. The term “focusing element” is in the present disclosure intended to cover different types of equipment resulting in a selection of optical information from a small area. FIGS. 8A-C illustrate three examples of such focusing elements. In FIG. 8A, a focusing element 11, here in the form of a microlens 12, is provided at a distance from an image plane 26. Rays 75 from a small area 74 at the image plane 26 are refracted in the microlens 12, giving rise to a bunch of parallel rays 76 leaving the microlens 12. A viewer, looking at the microlens will only see the small area 74, enlarged to cover the entire area of the microlens 12.

In FIG. 8B, a focusing element 11, here in the form of a curved mirror 72, is provided at a distance from an essentially transparent image plane 26. Rays 75 from a small area 74 at the image plane 26 are reflected in the curved mirror 72, giving rise to a bunch of parallel rays 76 passing through the image plane 26. A viewer, looking at the image plane 26 will mainly see the small area 74, enlarged to cover the entire area of the curved mirror 72. The image of the small area is somewhat influenced by e.g. the small area 74 during the passage through the image plane 26. In this embodiment, the viewer will see a mirror image of the small area 74, since it is viewed through the curved mirror 72. The projection model for curved mirrors as focusing elements is more or less similar to the one for microlenses. However, the projection has to be provided with the projection origin positioned between the model and the virtual image plane. The projection origin is preferably selected to correspond to the centre of curvature of the curved mirror 72.

In FIG. 8C, a focusing element 11, here in the form of an aperture 77, is provided above an image plane 26. A ray 76 from a small area 74 at the image plane 26 is the only ray that can pass the plane of the aperture 77 in a predetermined direction. A viewer, looking at the plane of the aperture can only see the small area 74, however, in this embodiment not enlarged. The same projection model as for the microlens can be used here. The projection origin is then selected to correspond to the position of the aperture 77.

The present invention has several advantages. The connections between magnification and apparent depth, as given in traditional Moiré type images, are no longer valid. It thereby becomes possible to select the magnification and apparent depth independently of each other. Furthermore, since the present invention allows for models having projections covering more than one focusing element to be imaged, the resolution can be improved. This is possible since there is no connection between the size of the focusing elements and the resolution of the structures in the image plane. A small size of the focusing element does therefore not necessarily result in a lower relative resolution in the structures in the image plane, Larger models can thereby be imaged. This means that the limitation of what model complexity can be imaged is significantly reduced. Very detailed structures on relatively large objects can easily be achieved.

The sensitivity for rotation imperfections between focusing elements and image plane structures can also be reduced by the present invention. This facilitates the industrial production. However, a small drawback is that the linear alignment typically is requested to be very good. For most applications, it is preferable to have a local as well as global linear misalignment that is smaller than 10 μm, more preferably less than 3 μm, and most preferably less than 1 μm. Such alignment precisions are possible to achieve today, see e.g. the co-pending international patent application PCT/SE2008/051538.

By relaxing the connection between different properties according to the above discussion, there is a possibility to create new dynamics with angles in space, facilitating different special effects such as edge enhancing, shadowing, grey scale coloring, blinking glittering etc. A large number of new types of products can thus be realized by this new technique. Some non-exclusive examples are animations, blinking patterns, key applications, holographic memory, EAN codes etc.

One of the particular properties of integral image devices according to the present invention as compared to traditional Moiré images is the limitation in angle of view. Referring back again to FIGS. 2A to 2D, when the viewing angle changes, the imaged spot 15 will move across the image plane. When the imaged spot 15 passes the edge of a pixel, the apparent image may change abruptly. If the pixels of a cell are arranged all the way to the cell border and the cells are arranged touching each other, the abrupt change may consist of a flip from one picture to a similar picture displaced sidewards. This is caused by the imaged spot 15 moving into the cell originally intended for a neighboring focusing element. This becomes more pronounced when there are only one or a few pixels in each cell. In certain situations, such an effect may be disturbing, however, it is also possible to utilize these effects for creating new features.

By restricting the area of the cells (or pixels of the cells), the disappearance of the image may still be abrupt. However, there will be no immediate flip to another displaced image. Not until the imaged spot reaches the next cell, the displaced picture will appear, and then the connection to the disappearing image is no longer obvious and hence less disturbing. This is the situation in e.g. FIG. 1D, which illustrates an integral image device 10. The cells 24 occupy only a part of the area below the corresponding microlens 12, This means that the image created by the structures within the cell 24 is only visible in a restricted two-dimensional angle range, where the spot imaged by the microlens 12 is situated within the cell 24. When viewing the integral image device 10 in other directions, no image will be seen. The relation between the microlens 12 extension and the size and position of the cell 24 thereby determines in what directions relative the integral image device 10 the integral image can be seen.

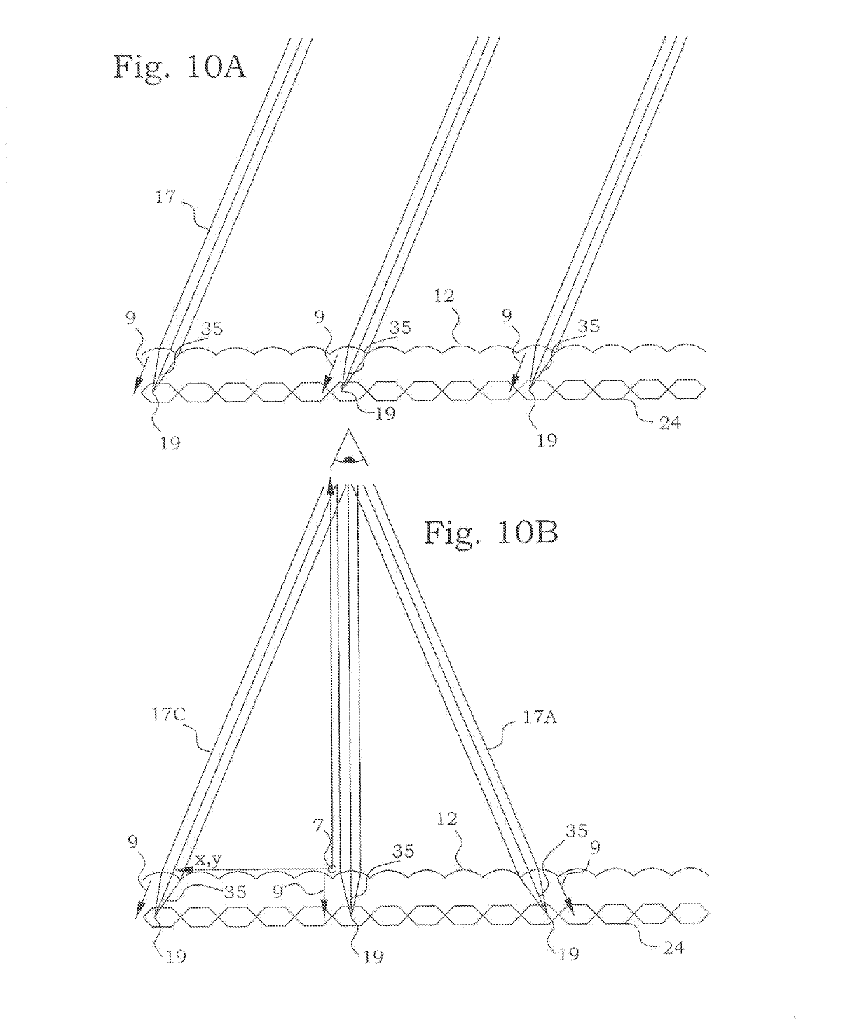

In FIG. 11A, these ideas are further developed. In this embodiment, an integral image device 10 comprises several portions 110A-C. In each portion 110A-C, the cells defining an integral image are limited in space in analogy with FIG. 1D. However, the integral images of the different portions may be different. This means that in each portion, a certain integral image corresponding to a certain model or set of models can be seen in a certain angle interval. The integral images as well as the viewing angle interval can differ from one portion to another. This thus opens up for different images to appear at different places at the integral image device 10 at different angles independently of each other.

The different cells 24 may also be present in one and the same portion, as indicated in FIG. 11B. Here, in portion 110D, two cells of different integral images of a model or set of models are present. Since they are situated in different parts of the area below the microlens 13, they are visible in different viewing directions, however, appear at the same place of the integral image device 10.

Such coexisting cells can also be overlapping, as illustrated in FIG. 11C. In such a situation, the structures in the overlapping parts of the cells have to be adapted to give rise to an integral image that shows an overlap of the different integral images. For instance, if one integral image is intended to be seen at a shallower depth than the other integral image, the latter should be hidden behind the first one in the image seen from the overlapping parts of the cells.

In a typical case, the maximum viewing angle is restricted by the size of the unit vectors of the focusing element array. By increasing the distances between the focusing elements, the possible viewing angle can thus be further increased, e.g. as illustrated in FIG. 11D.

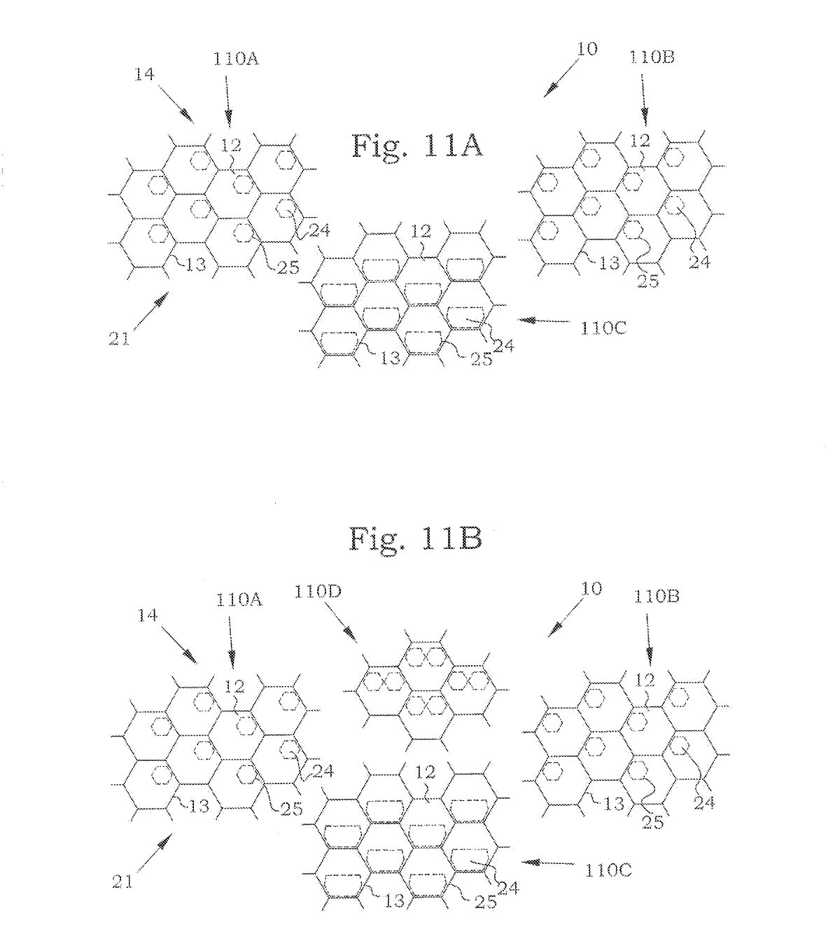

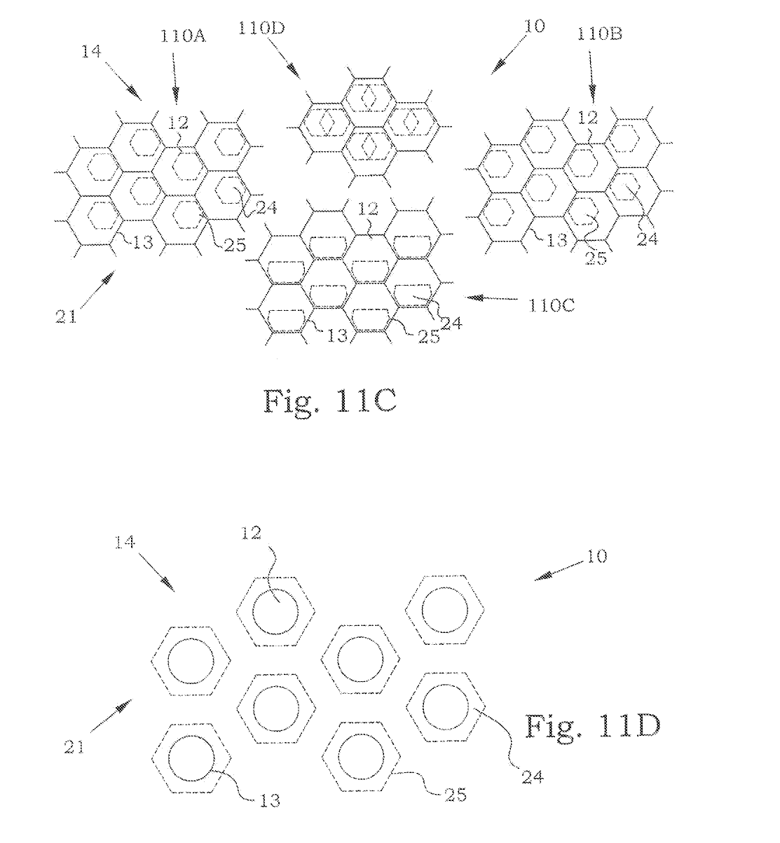

The result of integral image devices according to the above ideas is that the integral image device as a whole will present a number of different images at different or the same position at the integral image device, appearing and disappearing at different angles. One example is illustrated in FIGS. 12A-D. An integral image device 10 presents an image 112A when viewed in a certain direction relative the surface normal of the integral image device 10, as illustrated in FIG. 12A. The sideway tilting of the viewing angle corresponds to the angle V1 (and horizontally with the angle V3). The imaged spot at the image plane then falls within the cells having structures giving rise to the image 112A. When the integral image device 10 is turned sideways, as illustrated in FIG. 12B, another image 112B appears. The viewing angle is now parallel to the surface normal in the side direction, however, tilted an angle V3 in the horizontal direction. The respective imaged spots now fall within cells having structures giving rise to the image 112A as well as within cells having structures giving rise to the image 112B, at different portions of the integral image device 10. When the integral image device 10 is turned further sideways, as illustrated in FIG. 12C, the image 112B remains while the image 112A disappears. The sideway tilting of the viewing angle corresponds to the angle V2 (and horizontally with angle V3). The respective imaged spots now fall within cells having structures giving rise to the image 112B, while the imaged spots falls outside cells having structures giving rise to the image 112A. By instead turning the integral image device 10 vertically, as illustrated in FIG. 12D, both images 112A and 112B disappears and instead a third image 112C appears. The viewing angle is parallel to the surface normal in the side direction, however, tilted an angle V4 in the horizontal direction. The imaged spots have now reached cells of this third image.

FIG. 12E illustrates the situation of one particular microlens 12 and its associated part of the image plane. This microlens is assumed to be picked from the centre of the integral image device as indicated in FIG. 12B. In this spot, cells having information regarding all three images 112A-C are present at the image plane. When the situation is as illustrated in FIG. 12A, the viewing angle is V1 compared to the surface normal direction and the imaged spot 15A falls within cell 24A, having structures together forming the image 112A. However, since the imaged spot 15A falls outside the other cells, none of these images are seen. When the situation is as illustrated in FIG. 12B, the viewing angle is along the surface normal direction (in the sideway direction) and the imaged spot 15B falls within both cell 24A and cell 24B. Both images 112A and 112B are therefore visible. However, since the imaged spot 15B still falls outside the cell 24C, the image 112C is not seen. Finally, when the situation is as illustrated in FIG. 12C, the viewing angle is V2 compared to the surface normal direction (and in opposite direction compared to FIG. 12A) and the imaged spot 15C falls within cell 24B, having structures together forming the image 112B. However, since the imaged spot 15C falls outside the other cells, none of these images are seen.

This behavior can, as anyone skilled in the art realizes, be varied in unlimited manners to give rise to almost any type of “twinkling” patterns. This behavior can also be achieved by considering the entire image structure as an “animation”, which can be treated according to the animation principles sketched further above. In such case, the entire appearance of the integral image device can be considered as a single model or set of models, and the integral image device is manufactured accordingly.

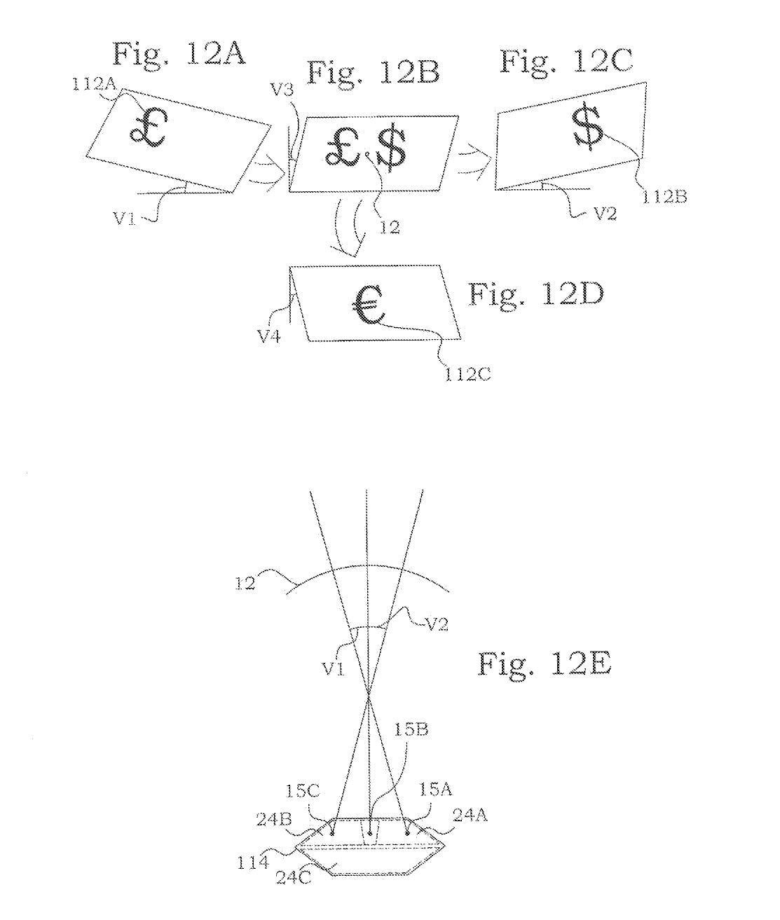

A particular example of an integral image device arranged for a deliberate “animation” is illustrated in FIG. 13. Four microlenses 12 and the associated image plane are shown. The illustrated microlenses are positioned spaced apart over the surface of the integral image device. In each image plane portion, a respective cell 24D-G is indicated by broken lines. These cells comprise structures which when combined with neighboring microlenses give rise to a letter. The letter is illustrated with broken lines in order to indicate that it is not a real structure in the image plane, but instead that the combination of light from several such image plane portions gives rise to an integral image of such a letter. When the integral image device is tilted sideways, the imaged spot of each microlens will travel over the corresponding image plane portion. When the imaged spots are situated far to the left side in the image plane portion, none of the cells 24D-G are hit, and no image is seen. When the integral image device is tilted sideways, the imaged spot for each of the microlenses will move horizontally (as depicted) over the respective image plane portion and enter into the respective cell 24D-G, one after the other. The result will be that the letter “E” first becomes visible, then the letter “X”, then the letter “I” and finally the letter “T”.

In the present examples, all letters will disappear at the same angle if the tilting of the integral image device continues. However, also such a disappearance can be scheduled to different angles by modifying the relative positions of the different cells, e.g. in analogy with the sequentially appearance.

The angle at which a cell is entered depends on the relative position of the microlens and the cell in question. The accuracy is therefore dependent on the aligning accuracy of the microlens vs. the image plane. This alignment might be difficult to achieve in mass-production. However, the angle differences between the angles at which successive letters appear is only dependent on the accuracy within the image plane itself. The distance in the microlens plane 116 is well defined and accurately known. By controlling the distance 118 between the positions of the cells 24D and 24E very accurately, the angle differences between when the letters “E” and “X” are become visible can be determined equally accurate. Since the distances within the image plane are very accurately known, such an appearance behavior is easily planned in detail.

If the accuracy in aligning the microlenses and image plane is low, it might happen that the “start” of the letter appearances occurs at a relatively shallow angle relative the surface, and thereby becomes difficult to detect. However, by providing the integral image device with different sets of similar cells, displaced by different distances relative the corresponding microlens, there will always be at least one set cells giving rise to letters placed almost aligned with the microlens. In other words, somewhere over the surface of the integral image device, there will exist a well-aligned set of cells, irrespective of the intentional alignment accuracy between image plane and microlenses.

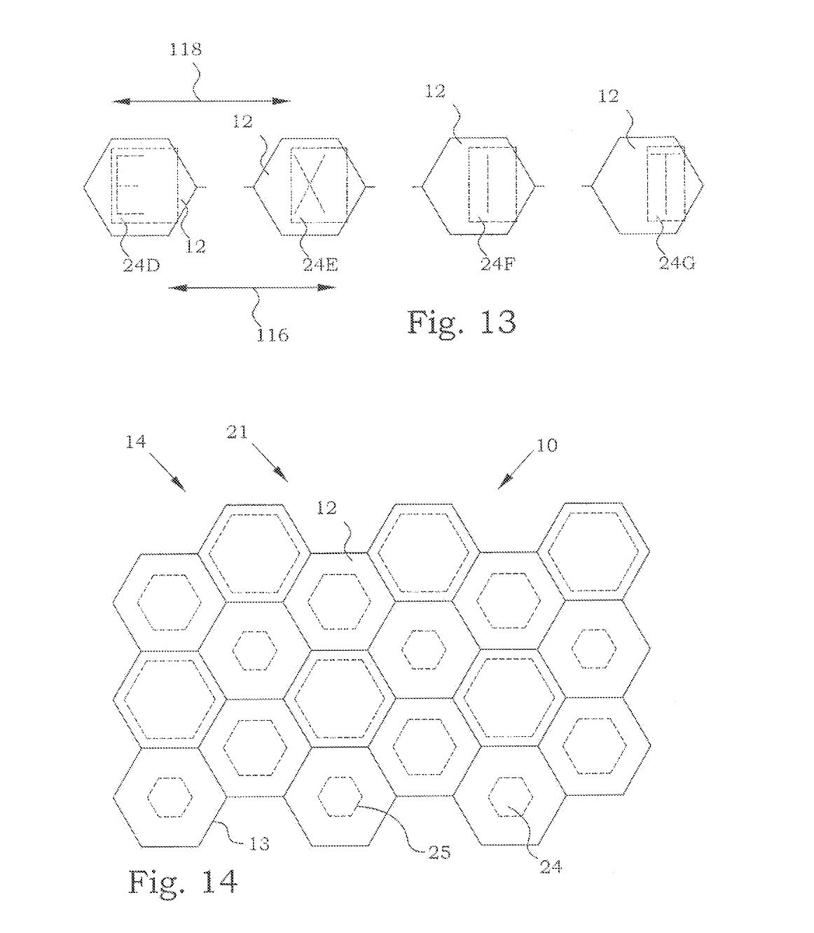

There are also possibilities to mitigate the abruptness of the disappearance and appearance of integral images. FIG. 14 illustrates an integral image device 10, where the different individual cells have different sizes and/or positions. Some cells have a small area, some a larger one. The result is that when the integral image device 10 is tilted, the imaged spot at the images plane will move as usual. However, the imaged spot will reach the cell border of some of the cells before it reaches the cell border of other cells. This results in that some parts of the integral image will disappear before all parts of the integral image disappears. By distributing the differently sized cells relatively even over the integral image device, the disappearance of the image will be gradual instead of abrupt. The image is perceived to fade away instead of disappearing.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. An integral image device, comprising:
a focusing element array of focusing elements in a focusing element plane; and
an image array of cells in an image plane;
said cells comprising structures that are optically distinguishable;
said image plane being situated at a distance from said focusing element plane being in a vicinity of a focal length of said focusing elements;
said structures together provide an integral image when being viewed through said focusing elements;
said structures of each individual cell being individually adapted to provide different scenes of said integral image for different angles in which said integral image is viewed;
said scenes presenting different viewing angles of a set of three-dimensional models;
said set of three-dimensional models comprising at least one three-dimensional model.

2. The integral image device according to claim 1, wherein said structures of each cell comprises structures corresponding to portions of a projection, made from a respective protection origin, of one three-dimensional model of said set of three-dimensional models onto a plane; said projection origins being in registry with said focusing element array.

3. The integral image device according to claim 1, wherein at least one cell comprises at least two pixels, wherein a pixel is a predetermined part of each ceil whereby structures in a particular pixel of said at least one cell being associated with a particular three-dimensional model of said set of three-dimensional model.

4. The integral image device according to claim 3, wherein three-dimensional models of said set of three-dimensional models are models of a same object viewed from different directions.

5. The integral image device according to claim 3, wherein three-dimensional models of said set of three-dimensional models are models of a same object viewed under different conditions.

6. The integral image device according to claim 3, wherein three-dimensional models of said set of three-dimensional models are models of a same object viewed with at least one of a different magnification and a different apparent depth.

7. The integral image device according to claim 3, wherein subsequent pixels ate associated with three-dimensional models of said set of three-dimensional models being models of objects presenting subsequent small differences, whereby said integral image device upon tilting presents an animation of said models of objects presenting subsequent small differences.

8. The integral image device according to claim 3, wherein three-dimensional models of said set of three-dimensional models are models of different objects.

9. The integral image device according to claim 3, wherein pixels m at least one cell overlap.

10. The integral image device according to claim 1, wherein said cells comprise at least one pixel, wherein a pixel is a predetermined part of each cell, whereby structures in a particular pixel of said at least one ceil being associated with a particular three-dimensional model of said set of three-dimensional model, wherein said at least one pixel in at least two of said cells have at least one of mutually differing size and mutually differing position within the respective cell; whereby said integral image is provided with a fade away effect.

11. The integral image device according to claim 1, wherein said structures of each cell comprises structures corresponding to portions of a projection, made from a respective projection origin, of one three-dimensional model of said set of three-dimensional models onto a plane; wherein directions of projection lines of said respective projection origins are non-parallel.

12. The integral image device according to claim 11, wherein directions of projection lines of said respective projection origins converge at an intended viewing distance, whereby a three-dimensional integral image is viewable at said intended viewing distance.

13. The integral image device according to claim 11, wherein directions of projection lines of said respective projection origins are dependent on an intended final curvature of said image plane, whereby a three-dimensional integral image is viewable when said integral image device is given said intended final curvature of said image plane.

14. The integral image device according to claim 1, wherein said structures are one of printed structures and embossed structures.
